(19) United States
(12) Patent Application Publication
(10) Pub. No.: US 2008/0303374 A1
(43) Pub. Date: Dec. 11, 2008

(54) MOTOR WITH ROTOR SHAFT AND ROTOR MAGNET

(75) Inventors: Masaki YOKOYAMA, Nagano (JP); Shinichi UTSUMI, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/131,600

(22) Filed: Jun. 2, 2008

(30) Foreign Application Priority Data
May 31, 2007 (JP) JP2007-146051
May 31, 2007 (JP) JP2007-146071

(51) Int. Cl. H02K 37/14

(52) U.S. Cl. 310/254; 310/49 R

(57) ABSTRACT

A motor may include a rotor, a first yoke and a second yoke which are disposed to face each other, and at least one coil which is disposed between the first yoke and the second yoke. The first yoke is provided with a fixing part on which the coil is mounted so as to extend in a direction parallel to a rotor shaft and the fixing part is formed with a projecting part protruded from a tip end of the fixing part. The second yoke is provided with a fixing hole and the projecting part of the fixing part of the first yoke is press-fitted to the fixing hole of the second yoke and, in this state, a tip end face of the fixing part supports the second yoke and a tip end part of the projecting part is protruded from the second yoke.

### CROSS REFERENCE TO RELATED APPLICATION

The present invention claims priority under 35 U.S.C. §119 to Japanese Application No. 2007-146051 filed May 31, 2007 and Japanese Application No. 2007-146071 filed May 31, 2007, both of which are incorporated herein by reference.

### FIELD OF THE INVENTION

An embodiment of the present invention may relate to a motor. More specifically, an embodiment of the present invention may relate to a motor in which a stator member is disposed on an outer side of a rotor magnet that is attached to a rotor shaft.

### BACKGROUND OF THE INVENTION

A PM type (Permanent Magnet Type) stepping motor has been conventionally known in which a permanent magnet is used in a rotor. For example, as shown in FIG. 27, a stepping motor 100 has been known in which coils 106 are disposed so as to surround an outer periphery of a plurality of pole teeth 104 which are formed to be bent from an inner circumferential edge of stator cores 102. In the stepping motor 100 described above, an entire size of the stepping motor 100 is determined by a diameter of the coil 106 and thus, in order to secure a predetermined number of winding to obtain a rotational torque, reduction of the size and width of the motor is limited.

On the other hand, a stepping motor whose width is made thinner has been known (see, for example, Japanese Patent Laid-Open No. Hei 1-99466), in which a pair of rectangular coils is disposed on both sides of pole teeth that are standingly formed on an inner periphery of the stator cores.

The flat type stepping motor 200 as described above is, as shown in FIG. 28, provided with stator members 212, each of which includes a yoke 206 which is formed with a plurality of pole teeth 202 standingly formed on its inner circumferential edge and fixing plates 204 formed so as to face the pole teeth 202, another yoke 208 which is formed with pole teeth 202 that are adjacently disposed to the pole teeth 202 of the yoke 206, and coils 210 into which the fixing plates 204 are inserted and which are fixed between the yoke 206 and the yoke 208. A rotor 216 in which a magnet (not shown) is integrally provided in a rotor shaft 214 is rotatably supported on an inner side of the pole teeth 202 of the stator members 212 through bearings.

In the stepping motor 200 structured as described above, a rotation drive force is applied to the rotor 216 by interaction between a magnetic field generated by an electric current flowing through the coil 210 and the magnet and rotation is outputted from one end side of the rotor shaft.

In order to fix the fixing plate 204 of one yoke 206 to the other yoke 208 in the motor described above, a tip end of the fixing plate 204 of one yoke 206 is commonly inserted into a through-hole or a cut-out part formed in the other yoke 208 and then an edge part of the through-hole or the cut-out part and a surface of the fixing plate 204 are joined and fixed to each other by welding or the like.

However, a relative displacement may occur in a positional relationship between the tip end of the fixing plate and the through-hole or the cut-out part on the basis of a press-fitted length of the fixing plate of the one yoke to the through-hole or the cut-out part of the other yoke. In this case, a stable strength may not be obtained in the welding between the tip end of the fixing plate and the through-hole or the cut-out part. As a result, product yield may be reduced.

### SUMMARY OF THE INVENTION

In view of the problems described above, at least an embodiment of the present invention may advantageously provide a motor in which a pair of yokes can be fixed so as not to be displaced in their relative positional relationship.

Thus, according to an embodiment of the present invention, there may be provided a motor including a rotor having a rotor shaft and a rotor magnet provided on an outer peripheral face of the rotor shaft, a first yoke and a second yoke which is disposed to face the first yoke, and at least one coil which is disposed between the first yoke and the second yoke. The first yoke is provided with a fixing part on which the coil is mounted and which is extended in a direction parallel to the rotor shaft, and the fixing part is formed with a projecting part which is protruded from a tip end of the fixing part. The second yoke is provided with a fixing hole which is penetrated through from one face of the second yoke opposed to the first yoke to the other face of the second yoke, and the projecting part is press-fitted to the fixing hole of the second yoke. In the state where the projecting part is press-fitted to the fixing hole, a tip end face of the fixing part is abutted with the one face of the second yoke and a tip end part of the projecting part is protruded from the other face of the second yoke. According to the structure as described above, in the state where the projecting part is press-fitted to the fixing hole, a tip end face of the fixing part is abutted with the one face of the second yoke and a tip end part of the projecting part is protruded from the other face of the second yoke. Therefore, positional relationship between the fixing part and the fixing hole can be determined accurately while preventing a press fitting depth of the fixing hole to the fixing part from becoming too shallow or too deep. Accordingly, displacement of relative positional relationship between of the first yoke and the second yoke can be prevented.

In this case, when a tapered face is formed at the tip end part of the projecting part, the projecting part can be smoothly inserted into the fixing hole.

Further, it is preferable that an outer peripheral face of the tip end part of the projecting part of the first yoke and an opening edge part of the fixing hole of the second yoke are welded so that the first yoke and the second yoke are fixed to each other. When the projecting part provided at the tip end part of the fixing part of the first yoke is press-fitted to the fixing hole provided in the joining plate of the second yoke from the one face side, the tip end part of the projecting part is protruded from the other face of the second yoke and thus the fixing hole and the projecting part is easily welded to each other. Therefore, the first yoke and the second yoke can be fixed firmly.

It is preferable that a frame which is mounted on the second yoke is provided with a mounting part abutted with and fixed to the other face of the joining plate and a bearing body for supporting one shaft end of the rotor shaft, and that the mounting part is formed with a recessed part, specifically a cut-out part, at a position corresponding to the fixing hole of the second yoke. According to this structure, even when the projecting part provided at the tip end of the fixing part of the first yoke is protruded from the fixing hole of the joining plate of the second yoke, the mounting part of the frame can be mounted so as to be abutted with the joining plate of the second yoke without a gap space.

Further, it is preferable that an inner peripheral face of the fixing hole is formed with an abutting part which abuts with a surface of the fixing part and a recessed part which faces the surface of the fixing part through a gap space. According to this structure, the fixing hole is fixed to the fixing part through the abutting part so as not to be displaced and thus the second yoke is firmly fixed to the first yoke without rattling. Further, the contacting area of the abutting part with the fixing part can be changed appropriately by setting the size of the recessed part to be larger or smaller and thus a load applied when the projecting part is press-fitted into the fixing hole can be adjusted.

Further, it is preferable that the fixing hole is formed in a polygonal shape and the recessed part is formed at a corner part of the polygonal shape. When the fixing part is formed of a plate member and its cross-sectional shape is in a polygonal or quadrangular shape, a burr may be formed at a corner part. According to the structure as described above, a burr of the fixing part can be effectively avoided at the edge part and the inner peripheral face of the fixing hole. Therefore, a clearance between the surface of the fixing part and the inner peripheral face of the fixing hole is not required to be set larger in consideration of the burr or the like of the fixing part and thus the surface of the fixing part and the inner peripheral face of the fixing hole are tightly contacted with each other over a portion except the recessed part. As a result, the fixing hole is fixed to the fixing part without displacement and thus the second yoke is firmly fixed to the first yoke without rattling. Further, plastic deformation of the fixing part and the second yoke due to a load at the time of press fitting can be prevented.

Further, the fixing hole may be formed in a rectangular shape and the recessed part is formed in a longitudinal direction of the rectangular shape. When the cross-sectional shape of the fixing part is rectangular, a burr may be formed in its longitudinal direction. According to the structure described above, the burr of the fixing plate can be effectively avoided from the edge part and the inner peripheral face of the fixing hole. Therefore, a clearance between the surface of the fixing part and the inner peripheral face of the fixing hole is not required to be set larger in consideration of the burr or the like of the fixing part and thus the surface of the fixing part and the inner peripheral face of the fixing hole are tightly contacted with each other over a portion except the recessed part. As a result, the fixing hole is fixed to the fixing part without displacement and thus the second yoke is firmly fixed to the first yoke without rattling.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an exploded perspective view showing a motor in accordance with an embodiment of the present invention.

FIG. 2 is a perspective view showing the motor in FIG. 1 which has been assembled.

FIG. 3 is a perspective view showing a stator which is structured of stator members superposed on each other.

FIG. 4 is an exploded perspective view showing a stator member which is provided in the motor shown in FIG. 1.

FIG. 5 is a view showing a state where pole-teeth parts of a second yoke are positioned to a first yoke.

FIG. 6 is a perspective view showing an outward appearance of the stator member.

FIG. 7 is a plan view showing a fixing plate in a connecting part of the first yoke which is viewed from an upper side.

FIG. 8 is a top plan view showing a pole-teeth part of the first yoke.

FIG. 9 is a top plan view showing a state where the fixing plate shown in FIG. 7 is fitted to the pole-teeth part shown in FIG. 8.

FIG. 10 is a cross-sectional view showing a coil bobbin in which a coil is not wound around yet.

FIG. 11 is an enlarged cross-sectional view showing a through-hole in a state where the fixing plate has been inserted into the through-hole of the coil bobbin shown in FIG. 10.

FIG. 12 is a plan view showing the pole-teeth part of the second yoke which is viewed from an upper side.

FIG. 13 is a top plan view showing a state where the fixing plate has been inserted into a fixing hole of the pole-teeth part shown in FIG. 12.

FIG. 14 is a plan view showing a joining plate of the second yoke which is viewed from an upper side.

FIG. 15 is a top plan view showing a state where projecting parts have been inserted into fixing holes of the joining plate of the second yoke.

FIG. 16 is an enlarged perspective view showing a state where a projecting part of the first yoke has been inserted into the fixing hole of the second yoke.

FIGS. 17(a) through 17(c) are views showing modified examples of a recessed part which is formed on the through-hole and/or the fixing hole.

FIG. 18 is a plan view showing an example of a wiring circuit board which is a resin film member.

FIG. 19 is a perspective view showing a state where terminals have been inserted into through-holes for terminal.

FIG. 20 is a perspective view showing an outward appearance of a motor to which the present invention is applied.

FIG. 21 is a partially cross-sectional view showing another motor in which a rotor is disposed on an inner side of a stator.

FIG. 22 is an exploded perspective view showing the stator in FIG. 21.

FIG. 23 is a top plan view showing a state where the rotor is disposed on an inner side of the stator shown in FIG. 22.

FIG. 24 is a plan view showing another example of a wiring circuit board which is a resin film member.

FIG. 25 is a perspective view showing a state before terminals of a stator are inserted into through-holes of a wiring circuit board.

FIG. 26 is a perspective view showing a state where a wiring circuit board has been wound around a stator and terminals have been inserted into connecting holes.

FIG. 27 is a partially cross-sectional view showing a conventional stepping motor.

FIG. 28 is a partially cross-sectional view showing a conventional flat type stepping motor.

### DETAILED DESCRIPTION OF THE PREFERRED EMBODIMENTS

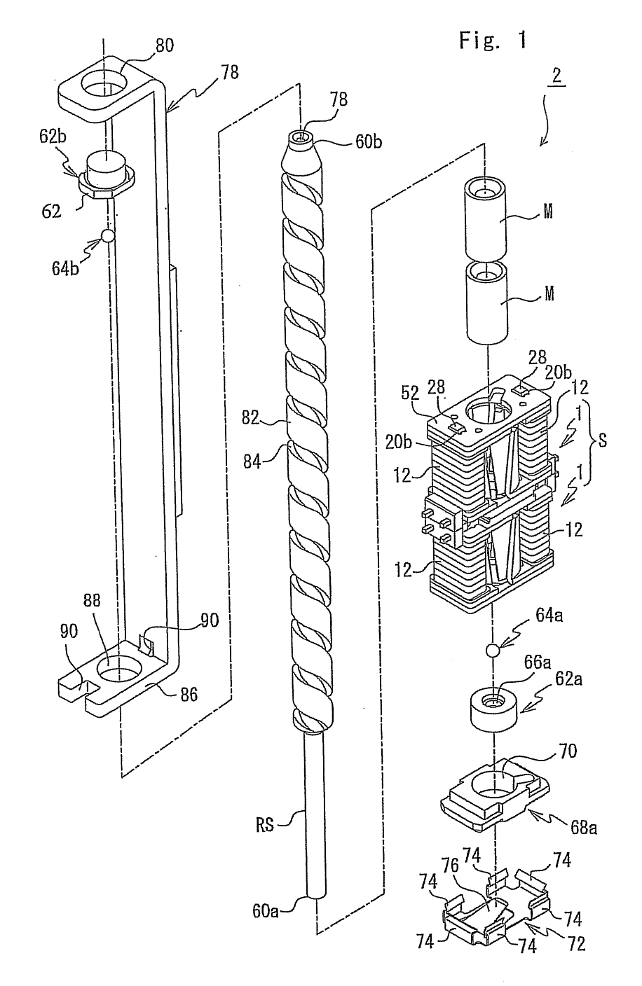

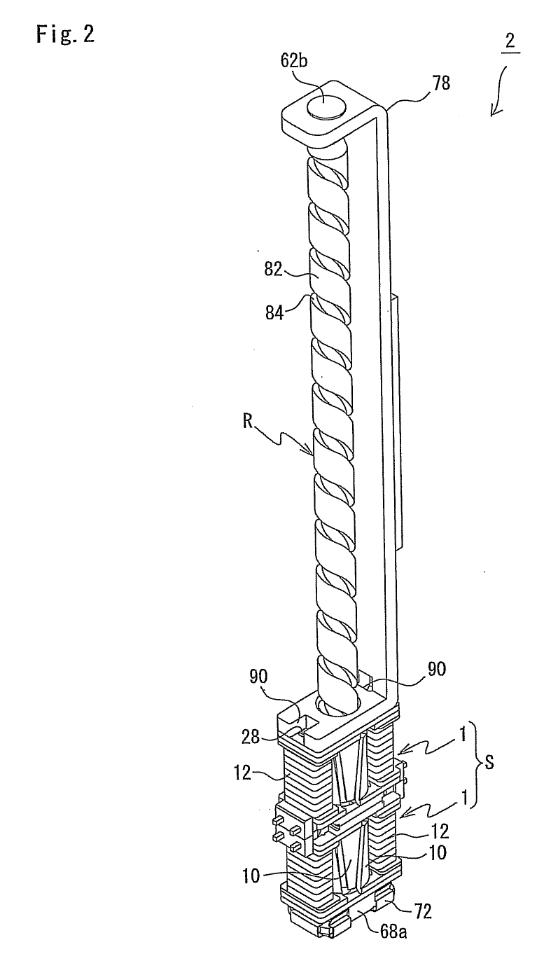

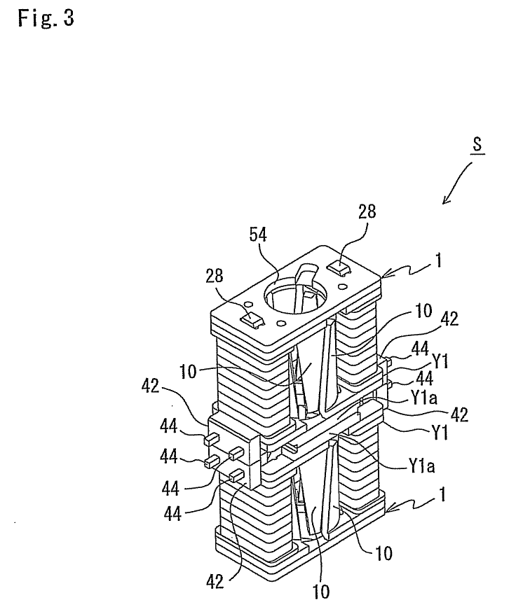

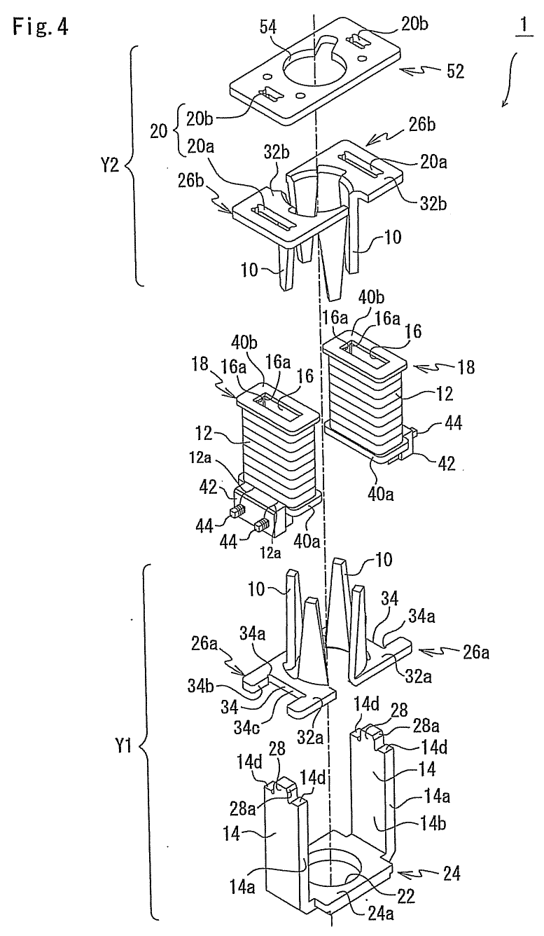

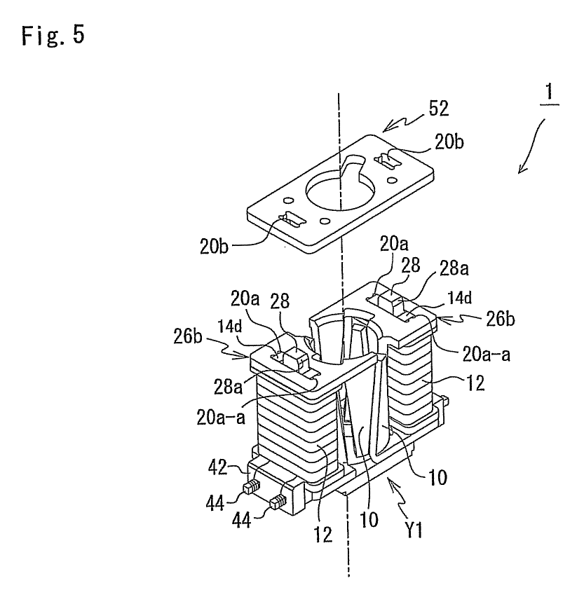

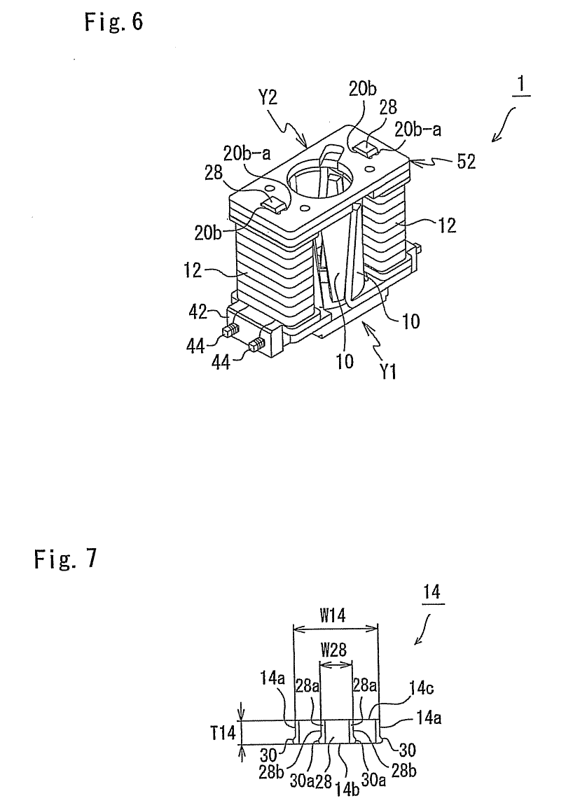

A motor 2 in accordance with an embodiment of the present invention will be described in detail below with reference to the accompanying drawings. FIG. 1 is an exploded perspective view showing a motor in accordance with an embodiment of the present invention. FIG. 2 is a perspective view showing the motor in FIG. 1 which has been assembled. FIG. 3 is a perspective view showing a stator S which is structured of two stator members superposed on each other. FIG. 4 is an exploded perspective view showing a stator member which is provided in the motor shown in FIG. 1. FIG. 5 is a view showing a state where pole-teeth parts of a second yoke are positioned to a first yoke. FIG. 6 is a perspective view showing an outward appearance of the stator member.

As shown in FIGS. 1 and 2, the motor 2 is provided with a stator S which is structured of two stator members 1 superposed on each other. As shown in FIG. 3, the stator S is structured such that respective first yokes Y1 of two stator members 1 are superposed on each other in a back to back manner and the respective terminal blocks 42 provided in the stator members 1 are structured so as to be superposed on each other. In these stator members 1, the end faces Y1a of the first yokes Y1 are welded in a spot-like manner and fixed to each other so that the pole teeth 10 of the respective stator members 1 are disposed in a coaxial manner.

A rotor R having a rotor shaft RS to which rotor magnets M are attached is disposed on an inner side of the stator S to structure the motor 2. The rotor R is provided with the rotor magnets M corresponding to the respective stator members 1 and the rotor magnets M are fixed on the outer periphery of the rotor shaft RS. Both ends of the rotor shaft RS are rotatably supported by bearing bodies 62a and 62b.

In the motor 2 provided with the stator S, interaction of a magnetic field which is generated when an electric current is supplied to coils 12 with the rotor magnet M occurs and a rotational driving force is applied to the rotor R and, as a result, rotation is outputted from a front end side of the rotor shaft RS.

A shaft end 60a on a base end side (opposite-to-output side) of the rotor shaft RS is supported by a bearing body 62a. The rotor shaft RS is supported through a steel ball 64a and the steel ball 64a is held by a concaved conical face (not shown) which is formed on the shaft end 60a of the rotor shaft RS and a concaved conical face 66a which is formed on the bearing body 62a. A plate-shaped bearing holder 68a made of a metal sintered body or the like is disposed on an opposite-to-output side end part (under side face in the drawing) of the stator S. The bearing body 62a is mounted on a through hole 70 for bearing body of the bearing holder 68a. A pressurization member 72 made of a metal plate is disposed on a further opposite-to-output side of the bearing holder 68a. The pressurization member 72 is fixed to the bearing holder 68a by means of that six pawl parts 74 extended to the bearing holder 68a side from its outer peripheral edge part of the pressurization member 72 are engaged with an outer peripheral edge part of the bearing holder 68a. A plate spring part 76 is cut and bent to the bearing side from the pressurization member 72. The plate spring part 76 urges the bearing body 62a which is mounted on the through hole 70 for bearing body toward the rotor shaft RS and applies a pressure to the rotor shaft RS to move its tip end side.

The shaft end 60b of the tip end side (output side) of the rotor shaft RS is rotatably supported by a bearing which is arranged in a frame 78. The frame 78 is fitted to an output side face of one of the stator members 1 of the stator S which is structured of two stator members 1 superposed on each other. In other words, the frame 78 is fitted to an upper face of the upper side stator member 1 shown FIG. 1, i.e., on an upper face of a joining plate 52 of the second yoke Y2 described below.

A steel ball 64b with which a concaved conical face 78 formed on the shaft end 60b of the rotor shaft RS is abutted and a bearing body 62b accommodating the steel ball 64b are arranged on the tip end side of the frame 78. The bearing body 62b is provided with a flange 62 larger than an inner diameter dimension of a mounting aperture 80 of the frame 78 and thus, when attached to the frame 78, the bearing body 62b is not detached in the axial direction.

A screw groove 84 is helically formed on the surface of a lead screw part 82 of the rotor shaft RS which is protruded from the stator S. The lead screw part 82 is provided with a function for parallel-moving a slider (not shown) engaging with the screw groove 84 in the axial direction with rotation of the rotor shaft RS. A moving direction of the slider is controlled by changing a direction of rotation of the rotor shaft RS.

As shown in FIG. 4, the stator member 1 includes a first yoke Y1, coil bobbins 18 around which a coil 12 is respectively wound and a second yoke Y2. The first yoke Y1 is formed with a plurality of pole teeth 10, where a magnetic pole of N-pole or S-pole is generated by supplying an electric current to the coils 12 and which is standingly formed on its inner circumferential edge, and fixing plates 14 which are a fixing part and to which the coil 12 is mounted and which are standingly formed on outer sides of the pole teeth 10. The coil bobbin 18 is provided with a through-hole 16 into which the fixing plate 14 of the first yoke Y1 is inserted. The second yoke Y2 includes a plurality of pole teeth 10 which is standingly formed so as to be adjacently disposed to the pole teeth 10 of the first yoke Y1 and fixing holes 20 to which the fixing plates 14 of the first yoke Y1 are inserted.

The first yoke Y1 is comprised of a connecting part 24 provided with a bottom plate 24a and a pair of pole-teeth parts 26a. The bottom plate 24a of the connecting part 24 is formed with an opening 22 for magnet through which the rotor magnets M are passed and the fixing plates 14 which are standingly formed on both sides of the bottom plate 24a as a fixing part for mounting the coil 12. Each of the pole-teeth parts 26a is standingly formed with a plurality of the pole teeth 10 along a peripheral edge of the opening 22 for magnet. The first yoke Y1 is formed of a magnetic steel plate such as iron, which is press-worked. In this case, the yoke is often pushed out from a die in a longitudinal direction at the time of working and forming the yoke. When the yoke is formed as described above, plastic deformation at the time of forming the yoke can be prevented. However, according to the forming method as described above, a burr 30 may be often formed in the longitudinal direction (see FIG. 7).

As shown in FIG. 4, the connecting part 24 is formed with the opening 22 for magnet at a center of the bottom plate 24a which is formed in a roughly rectangular shape and the strip-shaped fixing plates 14 are extended from edge portions of the bottom plate 24a so as to face each other. A pair of the fixing plates 14 are formed to be bent at a substantially right angle with respect to the bottom plate 24a so as to extend in the substantially same direction as the rotor shaft RS. The fixing plate 14 is formed with a projecting part 28 so as to protrude from a tip end face 14d of the fixing plate 14 for fixing a joining plate 52 for structuring the second yoke Y2 described below. The projecting part 28 is formed so that a tip end of the projecting part 28 is protruded from a fixing hole 20b of the joining plate 52 in the inserted state. In other words, a length from the tip end face 14d of the fixing plate 14 to the tip end face of the projecting part 28 is set to be a little larger than a thickness of the joining plate 52. Further, edge portions of the tip end of the projecting part 28 are cut obliquely to form tapered faces 28a.

The pole-teeth part 26a is structured so that a base portion 32a connecting the respective pole teeth 10 is disposed on a base end side of a plurality of the pole teeth 10 which is standingly formed along the peripheral edge of the aperture 22 for magnet of the connecting part 24. A cut-out part 34 to which the fixing plate 14 of the connecting part 24 is fitted is formed in an outer side portion of the base portion 32a and the fixing plate 14 is fitted to the cut-out part 34. The first yoke Y1 is a divided core which is structured of a pair of the pole-teeth parts 26a which are connected with each other by the connecting part 24.

The cut-out part 34 of the pole-teeth part 26a is fitted to the connecting part 24 from a tip end side of the fixing plate 14 of the connecting part 24 and the pole-teeth parts 26a are integrally assembled into the connecting part 24. As a result, the first yoke Y1 is structured in which the fixing plates 14 are standingly formed on both sides of a plurality of the pole teeth 10. In this embodiment, the connecting part 24 and the pole-teeth parts 26a are formed separately and then they are assembled to structure the first yoke Y1. However, the entire first yoke Y1 may be formed integrally, or the pole teeth 10 and the fixing plate 14 may be further separately formed and then they are assembled.

As shown in FIG. 4, the fixing plates 14 of the first yoke Y1 structured as described above are inserted into through-holes 16 of the coil bobbins 18 and the coils 12 are mounted on the first yoke Y1. In this embodiment, the cross-sectional shape of the fixing plate 14 and the cross-sectional shape of the through-hole 16 of the coil bobbin 18 are formed in substantially the same shape and thus the fixing plate 14 is pushed into the through-hole 16 with a little force and the fixing plate 14 is lightly press-fitted into the through-hole 16. In this case, the recessed part 16a is formed in the through-hole 16 of the coil bobbin 18 at the position corresponding to the burr 30 of the fixing plate 14. Therefore, even when a burr 30 is formed at a corner part of a cross section of the fixing plate 14, the burr 30 of the fixing plate 14 is not caught by an edge of the opening or the inner peripheral face of the through-hole 16 and thus the fixing plate 14 can be inserted into the through-hole 16 smoothly. Further, a size of the recessed part 16a formed at the position corresponding to the burr 30 is set to be a size that the abutting area of the fixing plate 14 with the through-hole 16 is reduced so that the fixing plate 14 is lightly press-fitted to the through-hole 16 with a desired pressing force. Accordingly, the light press fitting can be performed with a high degree of accuracy and assembling workability of the coil bobbin 18 to the first yoke Y1 is improved. Further, the fixing plate 14 is not required to be forcibly inserted into the through-hole 16 and thus a large force is not carelessly applied. Therefore, the first yoke Y1 is prevented from being deformed or the inner peripheral face of the through-hole 16 of the coil bobbin 18 is prevented from being scraped and thus the positional relationship between the pole teeth 10 of the first yoke Y1 and the coil 12 is not displaced and reduction of yield can be prevented.

As shown in FIG. 4, the second yoke Y2 is comprised of a pair of pole-teeth parts 26b which is standingly formed with a plurality of pole teeth 10 formed so as to be adjacently disposed to the pole teeth 10 of the first yoke Y1 and the joining part 52 for fixing the pole-teeth parts 26b of the second yoke Y2 to each other and for fixing the second yoke Y2 to the first yoke Y1. The pole-teeth parts 26b are divided cores including divided base portions 32b. A pair of the pole-teeth parts 26b are respectively formed with a fixing hole 20a into which the fixing plate 14 is inserted and the joining plate 52 is formed with fixing holes 20b into which the projecting part 28 formed at the tip end of the fixing plate 14 is inserted. The second yoke Y2 is formed of a magnetic steel plate such as iron, which is press-worked.

As shown in FIG. 4, the tip end of the fixing plate 14 of the first yoke Y1 is inserted into the fixing hole 20a formed in the pole-teeth part 26b of the second yoke Y2 to position the pole-teeth part 26b of the second yoke Y2 to the first yoke Y1. In this embodiment, the cross-sectional shape of the fixing plate 14 and the cross-sectional shape of the fixing hole 20a are formed in substantially the same shape and thus, when the fixing plate 14 is pushed into the fixing hole 20a with a little force, the fixing plate 14 can be lightly press-fitted into the fixing hole 20a. In this case, the recessed part 20a-a is formed in the fixing hole 20a at the position corresponding to the burr 30 of the fixing plate 14. Therefore, even when a burr is formed at a corner part of the cross section of the fixing plate 14, the burr 30 of the fixing plate 14 is not caught by an edge of the opening or the inner peripheral face of the fixing hole 20a and thus the fixing plate 14 can be inserted into the fixing hole 20a smoothly. As a result, assembling workability of the pole-teeth part 26b of the second yoke Y2 to the first yoke Y1 is improved. Further, the fixing plate 14 is not required to be forcibly inserted into the fixing hole 20a and thus a large force is not required to be carelessly applied. Therefore, the pole-teeth parts 26a and/or 26b of the first yoke Y1 and/or the second yoke Y2 are prevented from being deformed and thus the positional relationship between the pole teeth 10 of the first yoke Y1 and the pole teeth 10 of the second yoke Y2 is not displaced and reduction of yield can be prevented.

In addition, as shown in FIG. 4, the joining plate 52 is a plate member which is formed at its center with an opening 54 for shaft through which the rotor shaft RS is passed. The joining plate 52 is formed with fixing holes 20b, into which the projecting part 28 provided at the tip end of the fixing plate 14 is inserted, on both sides of the hole 54 for shaft so as to penetrate from one face to the other face of the joining plate 52.

The joining plate 52 is fixed to the projecting part 28 formed at the tip end of the fixing plate 14 of the first yoke Y1 and, as a result, the pole-teeth parts 26b of the second yoke Y2 are fixed to each other and the second yoke Y2 and the first yoke Y1 are fixed to each other.

Two stator members 1 structured as described above are superposed on each other to structure the stator S as shown in FIG. 3. The stator S is mounted on the motor in this embodiment.

As shown in FIG. 1, the frame 78 is attached to the stator S by means of that its mounting part 86 is superposed on and joined to the upper face of the stator S. A hole 88 for shaft into which the rotor shaft RS is passed is formed at the center of the mounting part 86 and recessed parts 90 for projecting part are formed on its both sides. The mounting part 86 is disposed so as to be superposed on the upper face of the stator S. In this case, the tip ends of the projecting parts 28 formed at the tip ends of the fixing plates 14 of the first yoke Y1 are protruded from the upper face of the stator S, in other words, from the end face of the second yoke Y2 of the stator member 1 on the output side of the stator S. According to this embodiment, since the recessed parts 90 are formed, the mounting part 86 can be abutted with the upper face of the stator S without a gap space while avoiding the projecting parts 28. In the motor 1 shown in FIG. 2, a cut-out part is formed as an example for the recessed part 90. However, the recessed part is not limited to a cut-out part. For example, the recessed part may be formed in a groove shape, in other words, it may be formed in a concave shape so as not to abut with the tip end of the projecting part 28.

An outer end face of the mounting part 86 of the frame 78 and an outer end face of the second yoke Y2 of the stator member 1 on the output side of the stator S are formed in substantially the same size in the radial direction. Therefore, the end faces of the mounting part 86 and the second yoke Y2 are joined to each other by spot welding or the lice to fix the frame 78 to the stator S. As a result, the rotor magnets M attached to the rotor shaft RS is disposed in the inner side of the stator S.

FIG. 7 is a top plan view showing the fixing plate 14 of the first yoke Y1. In the first yoke Y1 of the stator member 1, a burr which is protruded in a plate thickness direction is formed on an end face of the connecting part 24 by press working when the connecting part 24 is punched. In addition, the burr which is protruded in the plate thickness direction may be deformed by press working for bending the fixing plates 14 on the both sides of the bottom plate 24a to cause the burr 30 to protrude in a face direction of the fixing plate 14. In this case, as shown in FIG. 7, the burr 30 is formed so as to protrude in the same direction as a long side of the fixing plate 14 having a substantially rectangular cross section from both ends of the long side. In addition, FIG. 7 is a view showing an example of the burr 30 which is formed on both sides of the one face 14b of the fixing plate 14. However, the burr may be formed so as to protrude from four corners of the substantially rectangular cross section in the both faces of the fixing plate 14. Further, the burr 30 may be formed over the entire circumference of the fixing plate 14 or may be formed partially. Alternatively, the burr may not be formed.

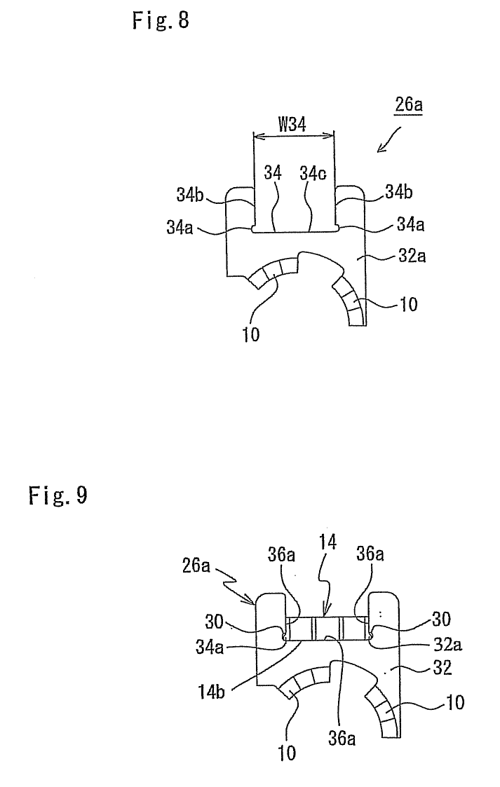

FIG. 8 is a top plan view showing the pole-teeth part 26a. The cut-out part 34 has substantially the same cross-sectional shape as that of the fixing plate 14. As shown in FIG. 7, the fixing plate 14 is formed in a substantially rectangular cross section and thus the cut-out part 34 is formed so that one side of the pole-teeth part 26a is cut out in a substantially rectangular shape. A width W34 of the cut-out part 34 is set to have substantially the same dimension as a width W14 of the fixing plate 14.

In addition, the cut-out part 34 is formed with a recessed part 34a in a concave shape at a position corresponding to the corner parts in the cross section of the fixing plate 14. As shown in FIG. 7, the burr 30 is easily formed at corner parts of the cross section of the fixing plate 14 and the burr 30 of the fixing plate 14 may be formed so as to protrude in the face direction from edge portions of one face 14b of the fixing plate 14. Therefore, the recessed parts 34a of the cut-out parts 34 are formed in a concave shape on an inner side of side faces 34b of the cut-out parts 34 so as not to abut with the burr 30. Further, for example, even when the burr is not formed, the recessed part may be formed beforehand at a position where a burr may be formed.

In this embodiment, the recessed part 34a is formed in the cut-out part 34 of the pole-teeth part 26a. Therefore, when the fixing plate 14 is to be inserted into the cut-out part 34, the burr 30 of the fixing plate 14 is not caught by the edge portion of the cut-out part 34 and thus the fixing plate 14 can be smoothly inserted into and fitted to the cut-out part 34. Accordingly, workability of connecting the pole-teeth part 26a with the connecting part 24 is improved. Further, the fixing plate 14 is not required to be forcibly inserted into the cut-out part 34 and thus a large force is not carelessly applied. Therefore, the first yoke is not deformed and thus reduction of yield can be prevented.

In addition, the recessed part 34a is formed on the cut-out part 34 of the pole-teeth part 26a and thus the width W34 of the cut-out part 34 is not required to be made larger in consideration of the size of the burr 30 of the fixing plate 14. Therefore, a clearance between the outside shape of the fixing plate 14 and a portion of the pole-teeth part 26a except the recessed part 34a of the cut-out part 34 can be set extremely small.

FIG. 9 is a top plan view showing a state where the pole-teeth part 26a is fitted to the fixing plate 14. An abutting part 36a which just abuts with end faces 34b, 34b and 34c of the cut-out part 34 is formed in a portion except the burr 30 of the fixing plate 14. In FIG. 9, both end faces 14a of the fixing plate 14 and both side faces 34b of the cut-out part 34 are abutted with each other. Further, the end face 34c on the inner side of the cut-out part 34 and the one face 14b of the fixing plate 14 are abutted with each other. In this manner, the pole-teeth part 26a is firmly fixed to the connecting part 24 without rattling and thus a characteristic of the stator member 1 is stable and reduction of yield can be prevented.

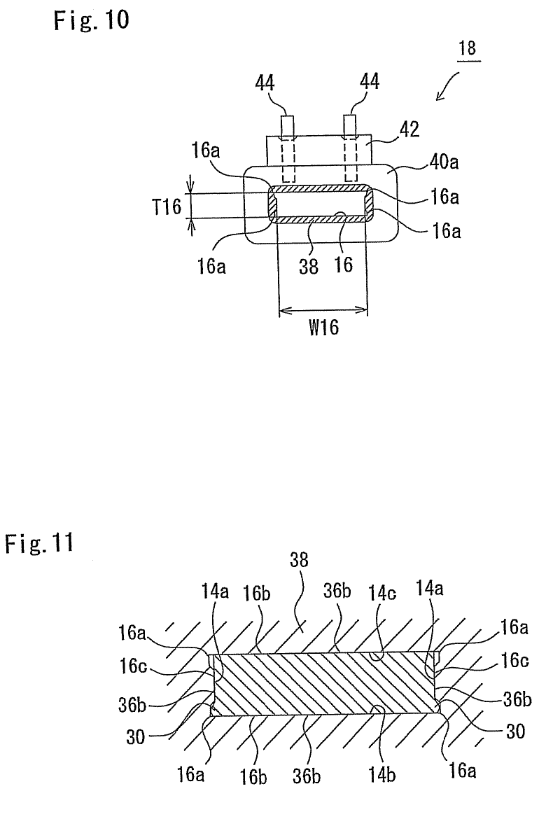

FIG. 10 is a cross-sectional view showing the coil bobbin 18 in which a coil is not wound around yet. As shown in FIGS. 4 and 10, the coil bobbin 18 is formed with flanges 40a and 40b at both ends of a main body 38 formed in a rectangular tubular shape and a terminal block 42 is formed at an outer edge portion of the flange 40a. A coil wire which is made of a copper wire or the lice whose surface is coated with insulating layer is wound around the main body 38 of the coil bobbin 18 plural times to structure the coil 12. Both end parts 12a of the coil are bound around a pair of terminals 44 provided in the terminal block 42 and an electric current is supplied to the coil 12 through the terminals 44.

In this embodiment, a bipolar drive in which the respective coils 12 are serially-connected with their winding directions are the same and, alternatively, a unipolar drive in which the respective coils 12 are serially-connected but their winding directions are opposite to each other may be applied to power feeding to the coils 12 provided in the stator member 1.

The through-hole 16 into which the fixing plate 14 of the first yoke Y1 is inserted is formed at the center of the coil bobbin 18. As shown in FIG. 10, the through-hole 16 has substantially the same shape as the cross-sectional shape of the fixing plate 14. As shown in FIG. 7, since the fixing plate 14 is formed in a substantially rectangular cross section, the through-hole 16 is also formed in a substantially rectangular cross section. Further, a length T16 of a short side of the rectangular cross section is set to be substantially the same as the plate thickness T14 of the fixing plate 14 and a length W16 of its long side is set to be substantially the same as the width W14 of the fixing plate 14 and thus the fixing plate 14 is lightly press-fitted to the through-hole 16.

In addition, the recessed part 16a is formed in a concave-shape at a corner position corresponding of the cross section of the fixing plate 14 for avoiding the burr 30 shown in FIG. 7. The recessed part 16a is formed in a groove shape, which is recessed in the long side direction, at four comers of inner peripheral faces of the substantially rectangular-shaped cross section of the through-hole 16. As shown in FIG. 7, the burr 30 of the fixing plate 14 is formed only at the edge portions of one face 14b of the fixing plate 14 but the recessed parts 16a of the through-hole 16 of the coil bobbin 18 are formed at four corners of the rectangular shape so as to recess in the long side direction. In this manner, since the recessed parts 16a are formed at four corners of the through-hole 16, even when a direction of the coil bobbin 18 is changed, the recessed part 16a can be disposed at the position corresponding to the burr of the fixing plate 14. Further, even when the burr is formed at edge portions of both faces of the fixing plate 14, the burr can be accommodated in the recessed part 16a.

In addition, the recessed part 16a is formed on the through-hole 16 of the coil bobbin 18 at the position corresponding to the burr 30 of the fixing plate 14. Further, the size of the recessed part 16a is set to be a size that the abutting area of the fixing plate 14 with the through-hole 16 is reduced so that the fixing plate 14 is lightly press-fitted to the through-hole 16 with a desired pressing force. In other words, the recessed part 16a is formed larger than the size of the burr 30. Therefore, the entire size of the through-hole 16 is not required to be made larger in consideration of the size of the burr 30 of the fixing plate 14. Accordingly, a clearance between the outside shape of the fixing plate 14 and a portion of the through-hole 16 except the recessed part 16a can be set extremely small.

FIG. 11 is an enlarged cross-sectional view showing a state where the fixing plate 14 has been inserted into the through-hole 16 of the coil bobbin 18. As described above, since the clearance between the outside shape of the fixing plate 14 and the through-hole 16 is set to be extremely small, in the state where the fixing plate 14 has been inserted into the through-hole 16, both faces 16b of the long side of the inner peripheral face of the through-hole 16 are abutted with one face 14b and the other face 14c (upper and lower faces in the drawing) of the fixing plate 14 and both faces 16c of the short side of the inner peripheral face of the through-hole 16 are abutted with both end faces 14a (right and left side faces). In this manner, the abutting part 36b which abuts with the surface of the fixing plate 14 without a clearance is formed on the inner peripheral face of the through-hole 16 and thus the coil bobbin 18 is firmly fixed to the fixing plate 14 without rattling. As a result, a characteristic of the stator member 1 becomes stable and reduction of yield can be prevented.

The second yoke Y2 is assembled and fixed to a protruded portion of the fixing plate 14 of the first yoke Y1 which is protruded from the through-hole 16 of the coil bobbin 18.

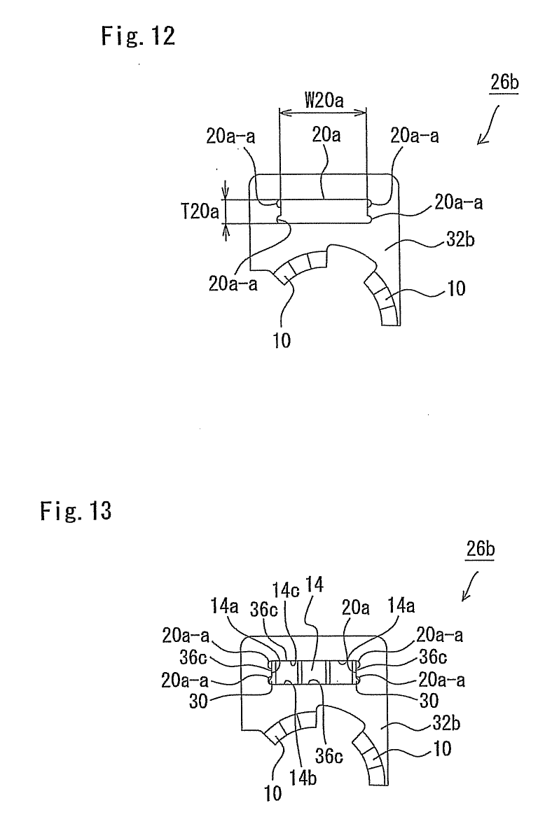

FIG. 12 is a plan view showing the pole-teeth part 26b which is viewed from an upper side. The fixing hole 20a of the base portion 32b has substantially the same shape as the cross-sectional shape of the fixing plate 14. As shown in FIG. 9, since the fixing plate 14 is formed in a substantially rectangular cross section, the fixing hole 20a is also formed in a substantially rectangular cross section. Further, a length T20a of a short side of the rectangular cross section is set to be substantially the same as the plate thickness T14 of the fixing plate 14 and a length W20a of its long side is set to be substantially the same as the width W14 of the fixing plate 14.

In addition, a recessed part 20a-a is formed in a concave-shape at a corner position corresponding to the cross section of the fixing plate 14 for avoiding the burr 30 as shown in FIG. 7. The burr 30 of the fixing plate 14 is formed only at the edge portions of one face 14b of the fixing plate 14 but the recessed parts 20a-a of the fixing hole 20a are formed at four corners of the rectangular shape so as to recess in the long side direction. In this manner, since the recessed parts 20a-a are formed at four corners of the fixing hole 20a, even when the burr is formed at edge portions of the other face or both faces of the fixing plate 14, the burr can be accommodated in the recessed part 20a-a.

In addition, the recessed part 20a-a is formed on the fixing hole 20a at the position corresponding to the burr 30 of the fixing plate 14. Further, the size of the recessed part 20a-a is set to be a size that the abutting area of the fixing plate 14 with the fixing hole 20a is reduced so that the fixing plate 14 is lightly press-fitted to the fixing hole 20a with a desired pressing force. In other words, the recessed part 20a-a is formed larger than the size of the burr 30. Therefore, the entire size of the fixing hole 20a is not required to be made larger in consideration of the size of the burr 30 of the fixing plate 14. Accordingly, a clearance between the outside shape of the fixing plate 14 and a portion of the fixing hole 20a except the recessed part 20a-a can be set extremely small.

FIG. 13 is a top plan view showing a state where the fixing plate 14 has been inserted into the fixing hole 20a of the pole-teeth part 26b. As described above, since the clearance between the outside shape of the fixing plate 14 and the fixing hole 20a is set to be extremely small, both faces of the long side of the inner peripheral face of the fixing hole 20a are abutted with the one face 14b and the other face 14c (upper and lower faces in the drawing) of the fixing plate 14 and both faces of the short side of the inner peripheral face of the fixing hole 20a are abutted with both end faces 14a (right and left side faces). In this manner, the abutting part 36c which abuts with the surface of the fixing plate 14 without a clearance is formed on the inner peripheral face of the fixing hole 20a. Therefore, the pole-teeth part 26b of the second yoke Y2 is positioned accurately and firmly fixed to the fixing plate 14 without rattling. As a result, a characteristic of the stator member 1 becomes stable and reduction of yield can be prevented.

As described above, a length of the projecting part 28 is formed slightly longer than a thickness of the joining plate 52. Therefore, in the state where the projecting part 28 has been inserted into the fixing hole 20b by press fitting, the tip end faces 14d of the fixing plate 14 are abutted with the one face of the joining plate 52 and the tip end of the projecting part 28 is protruded from the other face of the joining plate 52.

An outer peripheral end face -of the joining plate 52 is formed so as to be substantially the same size in the radial direction as outer peripheral end faces of the base portions 32b of the pole-teeth parts 26b in the state that the projecting parts 28 are inserted into the fixing hole 20b of the joining plate 52. Therefore, when the outer peripheral end face of the joining plate 52 is spot-welded at several points with the outer peripheral end faces of the pole-teeth parts 26b, a pair of the pole-teeth parts 26b are fixed to each other to structure the second yoke Y2.

In addition, an edge part of the fixing hole 20b and the surface of the projecting part 28 are fixed to each other by welding. In this manner, the joining plate 52 and the fixing plate 14 of the first yoke Y1 are fixed to each other and the first yoke Y1 and the second yoke Y2 are accurately positioned and fixed to each other.

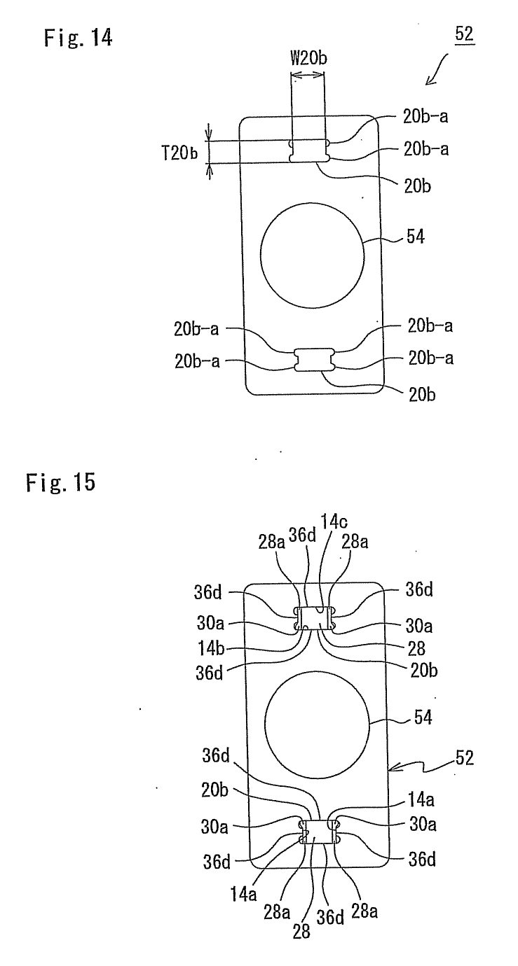

FIG. 14 is a plan view showing the joining plate 52 which is viewed from an upper side. The fixing hole 20b has substantially the same shape as the cross-sectional shape of the projecting part 28 of the fixing plate 14. As shown in FIG. 7, since the projecting part 28 is formed in a substantially rectangular cross section, the fixing hole 20b is also formed in a substantially rectangular cross section. Further, a length T20b of a short side of the rectangular cross section is set to be substantially the same as the plate thickness T14 of the fixing plate 14 and a length W20b of its long side is set to be substantially the same as the width W28 of the projecting part 28.

In addition, as shown in FIG. 14, a recessed part 20b-a is formed in a concave-shape at a corner position corresponding to the cross section of the projecting part 28 for avoiding the burr 30a as shown in FIG. 7 formed in the projecting part 28. The burr 30a of the projecting part 28 is formed only at the edge portions of the one face 14b of the fixing plate 14 but the recessed parts 20b-a of the fixing hole 20b are formed at four corners of the rectangular shape so as to recess in the long side direction. In this manner, since the recessed parts 20b-a are formed at four corners of the fixing hole 20b, even when the burr is formed at edge portions of the other face 14c or both faces 14b and 14c of the fixing plate 14, the burr can be accommodated in the recessed part 20b-a.

Further, as shown in FIGS. 4 and 7, edge parts of the tip end of the projecting part 28 are obliquely cut to be formed with tapered faces 28a. Therefore, when an opening edge part of the fixing hole 20b of the joining plate 52 is abutted with the tapered face 28a in order to insert the projecting part 28 into the fixing hole 20b of the joining plate 52, the fixing hole 20b is guided to a correct inserting position and thus assembling workability of the joining plate 52 to the projecting part 28 is improved.

FIG. 15 is a top plan view showing a state where the projecting parts 28 have been inserted into the fixing holes 20b of the joining plate 52. As described above, the cross-sectional shape of the projecting part 28 and the cross-sectional shape of the fixing hole 20b are formed in substantially the same shape and thus, when the projecting part 28 is pushed into the fixing hole 20b with a little force, the projecting part 28 can be lightly press-fitted into the fixing hole 20b. In this case, the recessed part 20b-a is formed in the fixing hole 20b at the position corresponding to the burr 30a of the projecting part 28. Therefore, the burr 30a of the projecting part 28 is not caught by an edge of the opening or the inner peripheral face of the fixing hole 20b and thus the projecting part 28 can be inserted into the fixing hole 20b smoothly. As a result, assembling workability of the joining plate 52 of the second yoke Y2 to the first yoke Y1 is improved. Further, even when the joining plate 52 is made of a magnetic member having a thin thickness, the projecting part 28 is not required to be forcibly inserted into the fixing hole 20b and thus a large force is not carelessly applied. Therefore, the joining plate 52 does not deform and thus the outer peripheral face of the pole-teeth part 26b and the outer peripheral face of the joining plate 52 are not displaced. Accordingly, the second yoke Y2 is prevented from being deformed and thus the positional relationship between the pole teeth 10 of the first yoke Y1 and the pole teeth 10 of the second yoke Y2 is not displaced and reduction of yield can be prevented.

In addition, the recessed part 20b-a is formed on the fixing hole 20b at the position corresponding to the burr 30a of the projecting part 28 and thus the entire size of the fixing hole 20b is not required to be made larger in consideration of the size of the burr 30a of the projecting part 28. Therefore, a clearance between the outside shape of the projecting part 28 and a portion of the fixing hole 20b except the recessed part 20b-a can be set to be extremely small. Accordingly, in the state where the projecting part 28 has been inserted into the fixing hole 20b, the one face 14b and the other face 14c (upper and lower faces in the drawing) of the projecting part 28 and its both faces 28b (right and left side faces) are abutted with the inner peripheral face of the fixing hole 20b over the roughly entire surface. In this manner, the abutting part 36d which abuts with the surface of the projecting part 28 without a clearance is formed on the inner peripheral face of the fixing hole 20b. Therefore, the first yoke Y1 and the second yoke Y2 are mutually positioned accurately. Further, in the recessed part 20b-a, a gap space is formed between the inner peripheral face of the fixing hole 20b and the outer peripheral face of the projecting part 28. However, the surface of the projecting part 28 and the opening edge part of the fixing hole 20b are welded to each other, and the outer peripheral face of the joining plate 52 and the outer peripheral faces of the pole-teeth parts 26b are welded to each other. Therefore, the first yoke Y1 and the second yoke Y2 are firmly fixed to each other in a state where they are mutually and accurately positioned to each other. As a result, a characteristic of the stator member 1 becomes stable and reduction of yield can be prevented.

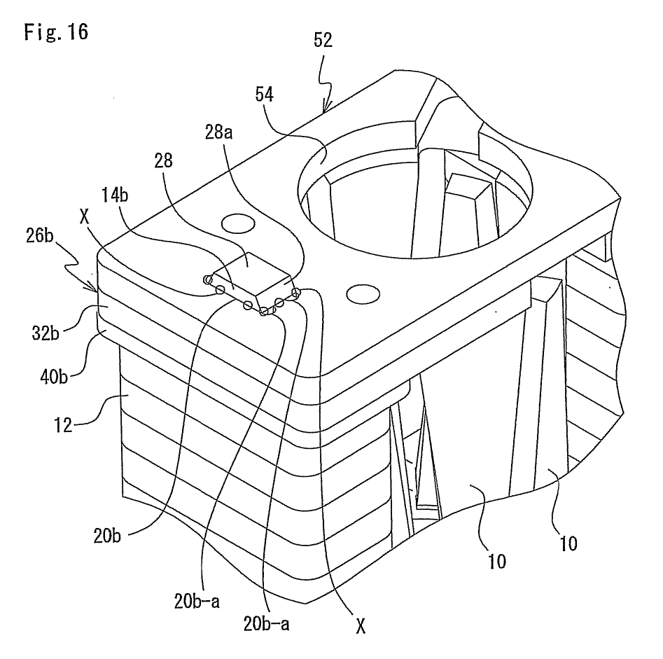

FIG. 16 is an enlarged perspective view showing a state where the projecting part 28 which is formed at the tip end of the fixing plate 14 of the first yoke Y1 has been inserted into the fixing hole 20b of the joining plate 52 of the second yoke Y2. As described above, when the stator member 1 has been assembled, the tip end of the projecting part 28 is protruded from the opening edge part of the fixing hole 20b. As shown in FIG. 15, both faces 14b and 14c and both end faces 28b of the projecting part 28 are abutted with the inner peripheral face of the fixing hole 20b over roughly the entire surface. On the other hand, in the recessed part 20b-a formed at the position corresponding to the burr 30a of the projecting part 28, the surface of the projecting part 28 and the inner peripheral face of the fixing hole 20b are faced each other through a gap space. When the opening edge part of the fixing hole 20b is spot-welded at several points, the joining plate 52 of the second yoke Y2 is fixed to the tip ends of the connecting part 24 of the first yoke Y1.

In FIG. 16, spot-welded points are shown by circles “X”, in other words, set at four corner portions of the opening edge part of the fixing hole 20b, at center portions of its short side, and at two portions on its long side. In this case, partially melted projecting part 28 is flown into a gap space between the recessed part 20b-a of the fixing hole 20b and the surface of the projecting part 28. In this manner, the gap space between the recessed part 20b-a of the fixing hole 20b and the surface of the projecting part 28 can be filled with the melted projecting part 28.

Further, as described above, the portion of the inner peripheral face of the fixing hole 20b except the recessed part 20b-a is abutted with the surface of the projecting part 28 without a clearance. Therefore, when a gap space of the recessed part 20b-a is filled up with the melted tip end of the projecting part 28, contacting area of the surface of the projecting part 28 with the inner peripheral face of the fixing hole 20b is increased and thus the joining plate 52 can be firmly fixed to the tip end of the fixing plate 14 of the first yoke Y1.

According to the embodiment described above, the projecting part 28 formed at the tip end of the fixing plate 14 is press-fitted to the fixing hole 20b so that the tip end face 14d of the fixing plate 14 of the first yoke Y1 is abutted with the one face of the joining plate 52 of the second yoke Y2. Therefore, positional relationship between the fixing plate 14 and the fixing hole 20b can be determined accurately by welding the fixing plate 14 to the fixing hole 20b while preventing a press fitting depth of the fixing hole 20b to the fixing plate 14 from becoming too shallow or too deep. Further, in this case, since the tip end of the projecting part 28 is protruded from the other face of the joining plate 52, welding between the fixing plate 14 and the fixing hole 20b is easily performed. Therefore, the fixing plate 14 can be properly welded to the fixing hole 20b and thus the joining plate 52 can be firmly and securely fixed to the tip end of the fixing plate 14 of the first yoke Y1.

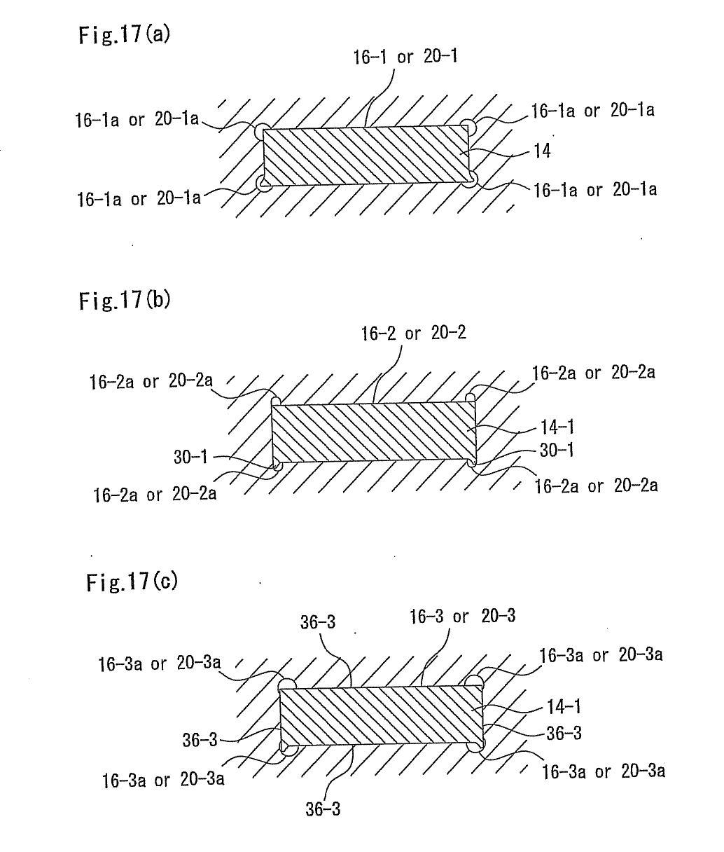

Next, modified examples of the shape of the through-hole which is provided in the coil bobbin and/or the shape of the fixing hole of the pole-teeth part and the fixing hole of the joining plate provided in the second yoke Y2 will be described below. In the description with reference to FIGS. 17(a) through 17(c), the fixing hole of the pole-teeth part and the fixing hole of the joining plate are simply referred to as a fixing hole and the same notational symbols are used for their descriptions. For example, as shown in FIG. 17(a), a recessed part 16-1a and/or a recessed part 20-1a formed in a circular recessed shape may be formed at corner parts of a through-hole 16-1 and/or a fixing hole 20-1 which are formed in a rectangular shape. Further, as shown in FIG. 17(b), when a burr 30-1 of the fixing plate 14-1 and/or the projecting part formed at its tip end is formed in a plate thickness direction of the fixing plate 14-1, a recessed part 16-2a and/or a recessed part 20-2a may be formed in a concave shape in a short side direction of a through-hole 16-2 and/or a fixing hole 20-2. Further, as shown in FIG. 17(c), widths of a recessed part 16-3a and/or a recessed part 20-3a which are formed in a concave shape on an inner peripheral face of a through-hole 16-3 and/or a fixing hole 20-3 may be set considerably larger than a size of a burr of the fixing plate 14-1. In this manner, when a width of the recessed part 16-3a and/or the recessed part 20-3a is changed, an area of an abutting part 36-3 can be changed where a surface of the fixing plate 14-1 and an inner peripheral face of the through-hole 16-3 and/or the fixing hole 20-3 are abutted with each other at the time when the fixing plate 14-1 has been inserted into the through-hole 16-3 and/or the fixing hole 20-3. When the width of the recessed part 16-3a and/or the recessed part 20-3a is set to be smaller, an area of the abutting part 36-3 becomes larger. On the contrary, when the width of the recessed part 16-3a and/or the recessed part 20-3a is set to be larger, an area of the abutting part 36-3 becomes smaller. In this manner, a force for press-fitting the fixing plate 14-1 into the through-hole 16-3 and/or the fixing hole 20-3 can be controlled.

According to the stator member 1 provided in the motor 2, in the state where the projecting part 28 of the first yoke Y1 has been press-fitted into the fixing hole 20b of the second yoke Y2, the tip end face 14d of the fixing plate 14 is abutted with the one face of the joining plate 52 and the tip end of the projecting part 28 is protruded from the other face of the joining plate 52. Therefore, positional relationship between the fixing plate 14 and the fixing hole 20b can be determined accurately without a press fitting depth of the fixing hole 20b to the fixing plate 14 becoming too shallow or too deep. Accordingly, displacement of relative positional relationship between of the first yoke Y1 and the second yoke Y2 can be prevented.

Further, since the tapered faces 28a are formed at the edge part of the projecting part 28, the projecting part 28 can be smoothly inserted into the fixing hole 20b.

In addition, the outer peripheral face of the tip end part of the projecting part 28 of the first yoke Y1 and the opening edge part of the fixing hole 20b of the second yoke Y2 are welded to each other and thus the first yoke Y1 and the second yoke Y2 are fixed to each other. In this case, when the projecting part 24 formed at the tip end face 14d of the fixing plate 14 of the first yoke Y1 is press-fitted from one face side into the fixing hole 20b formed in the joining plate 52 of the second yoke Y2, the tip end of the projecting part 28 is protruded from the other face of the joining plate 52 and thus the fixing hole 20b and the projecting part 28 are easily welded to each other. Therefore, the first yoke Y1 and the second yoke Y2 can be accurately positioned and firmly and securely fixed to each other.

In addition, the mounting part 86 of the frame 78 which is abutted with and fixed to the joining plate 52 and mounted on the second yoke Y2 is formed with recessed parts 90 at positions corresponding to the fixing hole 20b of the second yoke Y2. Therefore, even when the projecting part 28 which is formed at the tip end face 14d of the fixing plate 14 of the first yoke Y1 is protruded from the fixing hole of the joining plate 52 of the second yoke Y2, the mounting part 86 of the frame 78 can be abutted with and mounted on the joining plate 52 of the second yoke Y2 without a gap space. According to the structure in this embodiment, when the projecting part 28 is engaged with the recessed part 90, engagement of the projecting part 28 with the recessed part 90 can be functioned as a positioning of the frame 78 with the stator member 1. Therefore, positional accuracy between the frame 78 and the rotor shaft RS can be enhanced.

Further, the inner peripheral face of the fixing hole 20b of the joining plate 52 is formed with the abutting part 36d abutting with the surface of the fixing plate 14 and the recessed parts 20b-a facing the surface of the fixing plate 14 through a space. Therefore, the fixing hole 20b is fixed to the fixing plate 14 through the abutting part 36d so as not to be displaced and thus the second yoke Y2 is firmly fixed to the first yoke Y1 without rattling. Further, the contacting area of the abutting part 36d with the fixing plate 14 can be changed appropriately by setting the size of the recessed part 20b-a to be larger or smaller and thus a load applied when the projecting part is press-fitted into the fixing hole 20b can be adjusted.

Further, the fixing hole 20b is formed in a quadrangular shape, more specifically in a rectangular shape so as to correspond to the cross-sectional shape of the fixing plate 14 and, in addition, the recessed part 20b-a is formed at the corner parts in a longitudinal direction of the quadrangular shape. Therefore, the burr of the fixing plate 14 can be effectively avoided at the edge part and the inner peripheral face of the fixing hole 20b. Accordingly, a clearance between the surface of the fixing plate 14 and the inner peripheral face of the fixing hole 20b is not required to be set larger in consideration of the burr or the like of the fixing plate 14 and thus the surface of the fixing plate 14 and the inner peripheral face of the fixing hole 20b are tightly contacted with each other over a portion except the recessed part 20b-a. As a result, the fixing hole 20b is fixed to the fixing plate 14 without displacement and thus the second yoke Y2 can be fixed to the first yoke Y1 with a high degree of positional accuracy.

According to the motor 2 having the structure as described above, a pair of yokes can be fixed to each other so that their relative positional relationship is not displaced and thus deterioration of its yield can be prevented.

Although the present invention has been shown and described with reference to specific embodiments, various changes and modifications will be apparent to those skilled in the art from the teachings herein. For example, in the embodiment described above, two fixing parts are formed in the first yoke and two fixing holes corresponding to the fixing parts are formed in the second yoke. However, at least one fixing part and one fixing hole may be formed in the first yoke and the second yoke. Alternatively, it may be structured that one fixing part is formed in the first yoke and one fixing hole corresponding to the fixing part is formed in the second yoke and, in addition, one fixing part is formed in the second yoke and one fixing hole corresponding to this fixing part is formed in the first yoke. Further, in the embodiment described above, a plate-shaped fixing plate is used as the fixing part. However, the shape of the fixing part is not limited to this embodiment and, for example, a fixing part formed in a bar shape, a polygonal shape or the like may be used. In addition, forming of the recessed part is not limited to the second yoke and the coil bobbin. Among other various kinds of member used in a stepping motor, in a case that one member is inserted into and fixed to another member, the recessed part may be formed on a hole to be inserted. Further, the present invention is not limited to a stepping motor. For example, like a brushless motor, when a projecting part disposed on a circumferential face of a cylindrical stator core is inserted into a mounting hole formed at a center of the coil and a plurality of the coils is disposed on the circumferential face of the stator core, a recessed part may be formed on the mounting hole of the coil for avoiding a burr of the projecting part of the stator core.

In the embodiment described above, the outer end face of the mounting part 86 of the frame 78 and the outer end face of the second yoke Y2 of the stator member 1 on the output side of the stator S are disposed on substantially the same plane, i.e., in substantially the same size in the radial direction. The end faces of the mounting part 86 and the second yoke Y2 are joined to each other by spot welding or the like to fix the frame 78 to the stator S. As a result, the rotor magnets M attached to the rotor shaft RS are disposed in the inner side of the stator S and rotatably supported.

However, in this state, the coil 12 which is formed in a roughly rectangular shape and provided in the stator S is disposed so that one side face of its outer peripheral faces is opposite to the pole teeth but other three side faces are exposed as the outer peripheral face of the stator member 1 of the motor 2. When the outer peripheral face of the coil 12 is disposed on the outer peripheral face of the stator S as described above, the outer peripheral face of the coil 12 may be carelessly pressed or scratched and thus the coil wire may be disconnected. Further, in the stator S described above, a plurality of the pole teeth 10 which is adjacently disposed to each other is in an exposed state and thus foreign matters such as dust may enter into a space between the rotor magnet M and the pole teeth 10 from a gap space between the pole teeth 10 to cause a trouble to occur in the rotation of the rotor R.

In order to solve the problem described above, a resin film member P having flexibility is wound around the outer peripheral face of the stator member 1 to cover the outer peripheral face of the coil 12. In accordance with an embodiment of the present embodiment, a wiring circuit board 92 in which electro-conductive wiring patterns are formed on an insulating base film are utilized as the resin film member P.

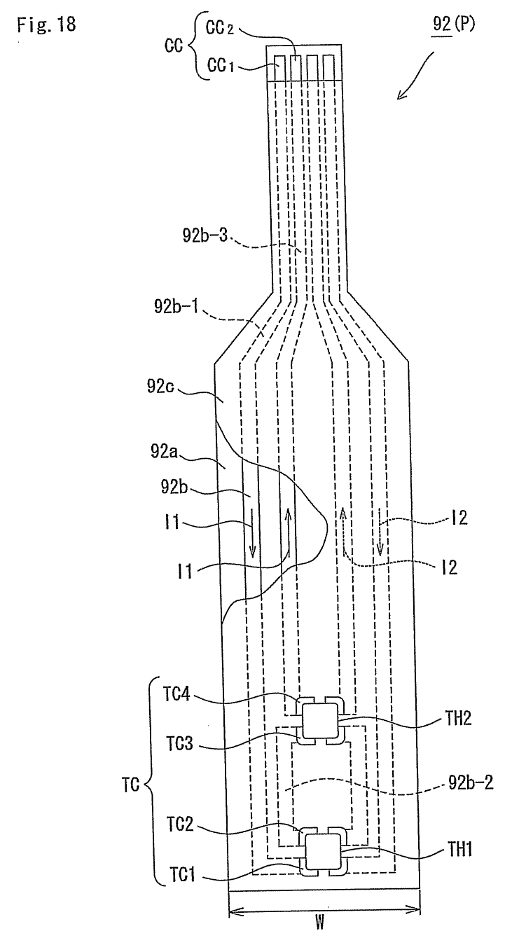

FIG. 18 is a plan view showing the wiring circuit board 92 in which a resin film is partially cut out in order to show the wiring patterns. The wiring circuit board 92 is formed in a band shape having a width W which is roughly the same length in the axial direction of the stator S so as to be capable of covering the outer peripheral face of the stator S with a sheet of the wiring circuit board 92. A flexible wiring circuit board which is commonly referred to as a flexible printed circuit board (FPC) may be utilized as the wiring circuit board 92. The wiring circuit board 92 is formed so that a conductor foil such as copper is laminated on a base film 92a made of resin having insulation property such as polyimide and patterning is performed on the conductor foil by etching in specific shapes to form the wiring patterns 92b and then a resin film 92c having insulation property such as polyimide is laminated on the wiring pattern 92b so as to cover roughly the entire base film 92a.

Through-holes TH for terminal are formed on one end part side of the wiring circuit board 92 at positions corresponding to the terminals 44 provided on the side face of the stator S. The stator S includes two sets of the coils 12 and each of the coils 12 is provided with two terminals 44. The eight terminals 44 in total are provided so that four of them are respectively disposed at center portions of both sides opposed to each other of the stator S.

The wiring circuit board 92 is formed with two through-holes TH1 and TH2 for terminal with a predetermined distance so that respective four terminals 44 provided on the both sides of the stator S can be passed through in a state that the wiring circuit board 92 is wound around the outer peripheral face of the stator S. The through-holes TH1 and TH2 for terminal are respectively formed in a roughly quadrangular shape so that four terminals 44 provided on one side face of the stator S are collectively passed through.

In addition, as shown in FIG. 18, terminal connecting parts TC which are respectively connected to the four terminals 44 passed through the through-holes TH1 and TH2 for terminal are formed at corner parts of the through-holes TH1 and TH2 for terminal on the periphery of the through-holes TH1 and TH2 for terminal. The terminal connecting part TC is integrally formed with the conductor foil in the same layer as the wiring pattern 92b, and the resin film 92c on the terminal connecting part TC is removed to expose the conductor foil, which can be connected to the terminal 44 with solder or the like.

A connecting part CC for connector is formed in the other end part of the wiring circuit board 92. The connecting part CC for connector is integrally formed with the conductor foil in the same layer as the wiring pattern 92b, and the resin film 92c on the connecting part CC for connector is removed to expose the conductor foil, which can be connected to connector terminals or the like. In this embodiment, a width of the connecting part CC for connector of the wiring circuit board 92 is formed narrowly and thus routing of the wiring circuit board 92 is easily performed.

An FPC connector which has been commonly used is utilized for a connector which is connected to the connecting part CC for connector and thus detailed description of its structure is omitted. Electric currents I1 and I2 are supplied to the connecting part CC for connector to supply to the coils 12 through the FPC connector.

The wiring pattern 92b of the wiring circuit board 92 is formed so that a pair of the coils 12 provided on both sides of the respective stator members 1 in the stator S is serially connected to each other.

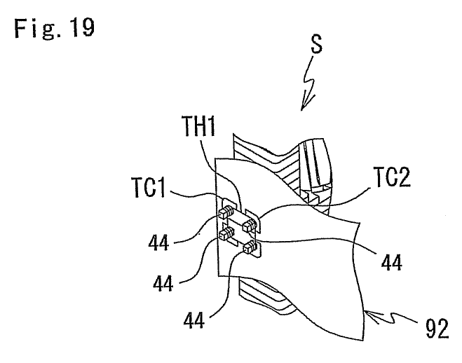

As shown in FIG. 19, the four terminals 44 provided at the center portion of one side face of the stator S are passed through the through-hole TH1 which is formed in the wiring circuit board 92. The four terminals 44 are disposed at the corner parts of the through-hole TH1 which is formed in a roughly quadrangular shape. The wiring circuit board 92 is inserted to a position abutting with the terminal block 42 which holds the terminals 44.

The respective terminals 44 are connected by soldering to the respective terminal connecting parts TC which are formed at the corner parts of the through-hole TH1 in the state where the terminals 44 are passed through the through-hole TH1 for terminal.

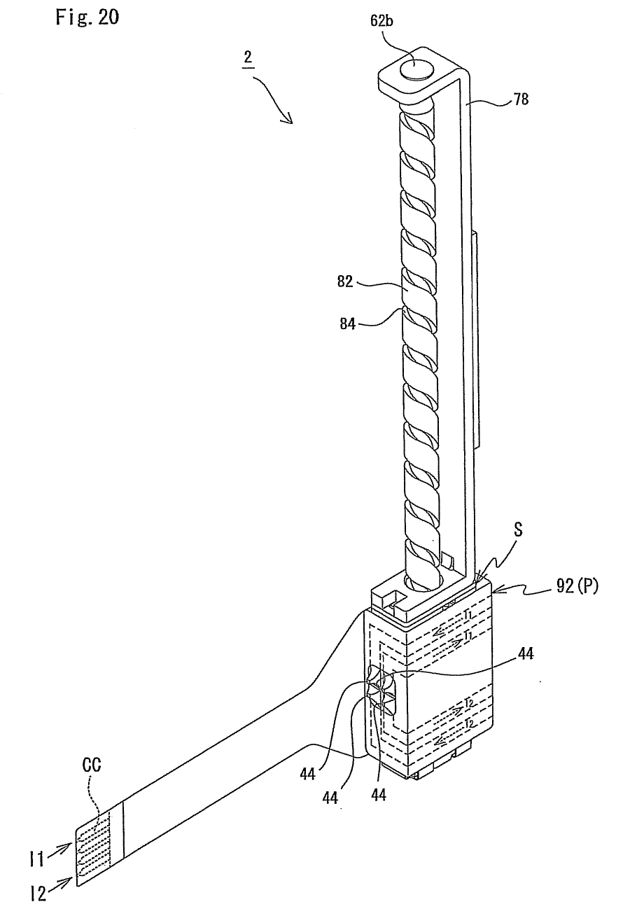

In this manner, the wiring circuit board 92 is fixed to the terminals 44 provided on the one side face of the stator S and, as shown in FIG. 20, the wiring circuit board 92 is wound around the outer peripheral face of the stator S. After that, the four terminals 44 provided on the other side face of the stator S are passed through the through-hole TH2 for terminal which is formed in the wiring circuit board 92. Four terminals 44 on the other side face are, similarly to the terminals 44 on the one side face, connected to the connecting parts TC for terminal which are provided on the outer peripheral edge of the through-hole TH2 for terminal.

In this manner, the respective four terminals provided on both sides of the stator S which is structured of two superposed stator members 1 on each other are respectively connected to the terminal connecting parts TC of the wiring circuit board 92. As a result, a pair of the coils 12 provided in the respective stator members 1 is connected so that an electrical power can be supplied.

As shown in FIG. 18, the wiring circuit board 92 is provided with wiring patterns 92b which are linearly symmetrically formed as two sets of wiring patterns to connect the coils 12 of the respective stator members 1.

In the state that the wiring circuit board 92 is connected to the terminals 44 of the stator S, an electric current Il inputted from the connecting part CC1 for connector is supplied to the terminal connecting part TC1 through a wiring pattern 92b-1 and then inputted to one end of one of the coils 12 of the stator member 1 through the terminal 44 connected to the terminal connecting part TC1 and outputted from the other end of the coil. The electric current I1 outputted from the other end of the one of the coils 12 is inputted to one end of the other of the coils 12 through the terminal connecting part TC2, a wiring pattern 92b-2 and the terminal connecting part TC3. Then, the electric current I1 is outputted from the other end of the other of the coils 12 through the terminal connecting part TC4 to be returned to the connecting part CC2 for connector through a wiring pattern 92b-3.

In the other stator member 1 of the stator S, similarly to the above-mentioned stator member, an electric current I2 inputted from the connecting part CC for connector is supplied through the coils 12 and then outputted from the other connecting part CC for connector.

In this manner, as shown in FIG. 20, the wiring circuit board 92 is connected to the terminals provided on both sides of the stator S and the wiring circuit board 92 is wound to surround the outer peripheral face of the stator S to structure the motor 2. In this case, it is preferable that the wiring circuit board 92 is wound so as not to contact with the contact faces of the stator members 1 contacting with each other. The corner parts of the base portions 32a and 32b and the bottom plate 24a in the contact faces protrude in the radial direction. When the wiring circuit board 92 is contacted with the corner parts of the base portions 32a and 32b and the bottom plate 24a, the wiring patterns 92b formed in the wiring circuit board 92 may be damaged. Therefore, it is preferable that the wiring circuit board 92 is wound so as not to contact with the contact faces of the stator S. Alternatively, arrangement of the wiring patterns 92 may be previously designed so that the wiring patterns 92b do not contact with the corner parts of the base portions 32a and 32b and the bottom plate 24a.

According to the motor 2 as described above, the outer peripheral face of the coils 12 disposed as the outer peripheral face of the stator member 1 is covered by a resin film member comprising of the wiring circuit board 92 and thus the outer peripheral face of the coil 12 is not touched directly from the outside and the coil winding is prevented from being disconnected. Further, foreign matters such as dust are prevented from entering from a space between the pole teeth 10 each other into a gap space between the rotor magnet M and the pole teeth 10. In addition, since the outer peripheral faces of the coils 12 are covered by the resin film member comprising of the wiring circuit board 92, the motor 2 is easily handled. In addition, the wiring circuit board 92 is utilized as the resin film member for covering and protecting the outer peripheral face of the coils 12. Therefore, the resin film member for covering and protecting the outer peripheral face of the coils 12 is provided with a function for supplying an electric current to the coils 12 and thus the size of the motor 2 can be reduced in comparison with a case when a conventional motor case is utilized.

In the embodiment described above, the wiring circuit board which is a resin film member is wound around the outer peripheral face of the stator after the rotor is disposed on the inner side of the stator. However, the rotor may be disposed on the inner side of the stator after the wiring circuit board is wound around the outer peripheral face of the stator. When the rotor is disposed on the inner side of the stator after the outer peripheral face of the stator is protected by the wiring circuit board, the stator can be easily handled when the rotor is to be mounted on the stator. Further, disconnection of the coil winding is prevented and yield of the motor can be improved.

In the embodiment described above, the wiring circuit board is used as the resin film member. However, the present invention is not limited to this embodiment and a flexible member which can be wound around the outer peripheral face of the stator may be used. In addition, in order that a resin film member is to be wound around the outer peripheral face of the stator, a resin film member which has been previously bent like the outer peripheral shape of the stator member may be used.

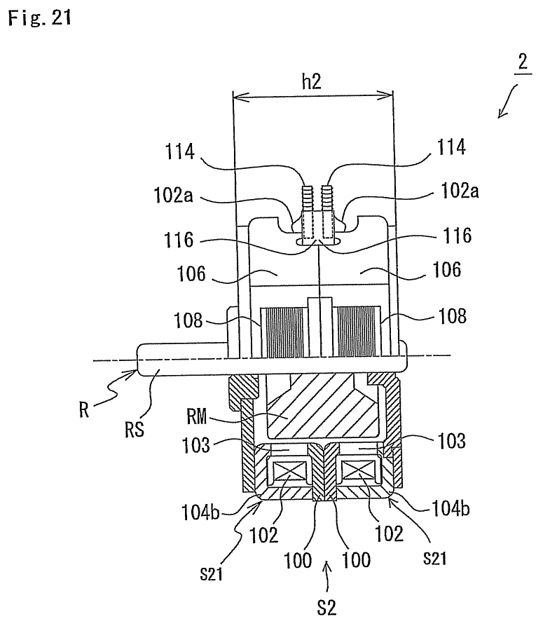

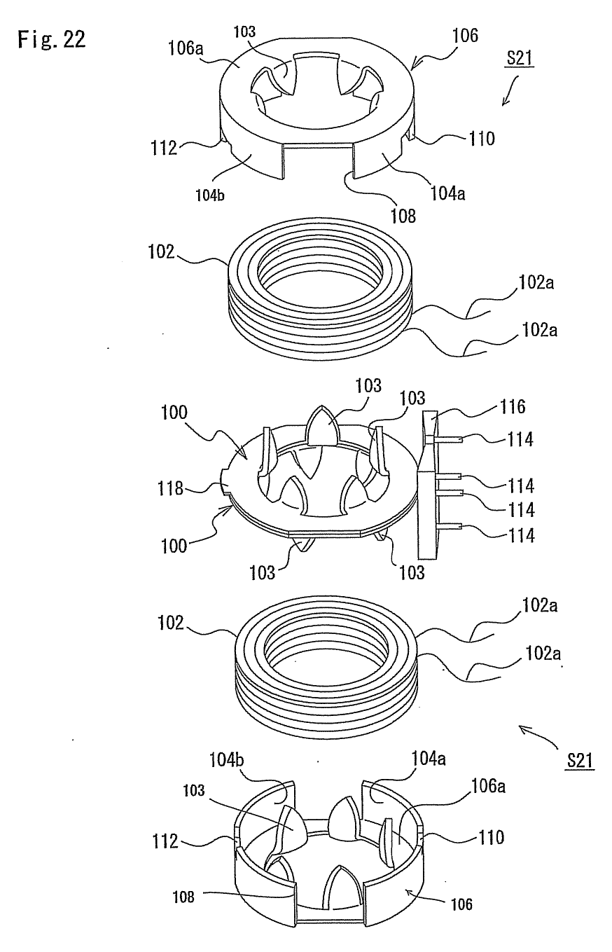

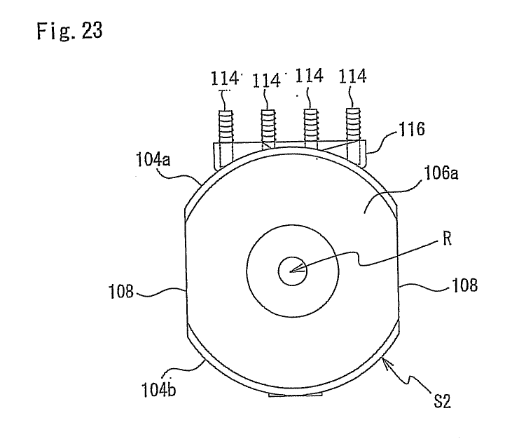

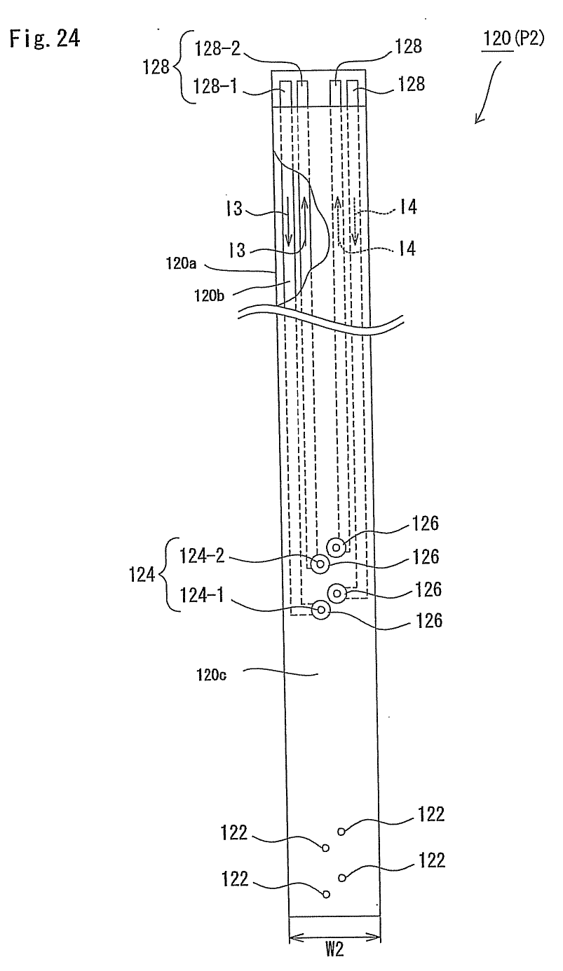

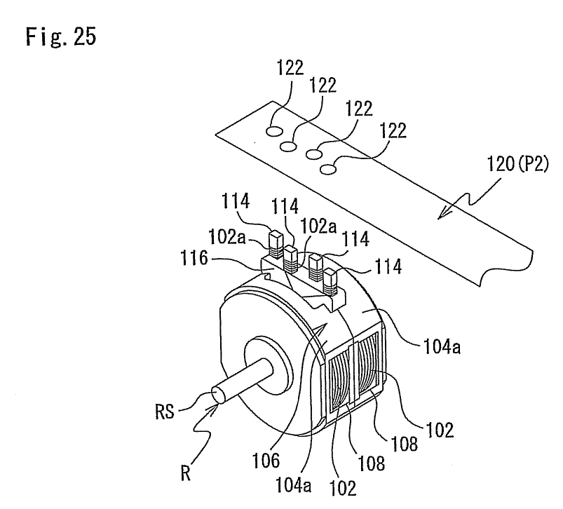

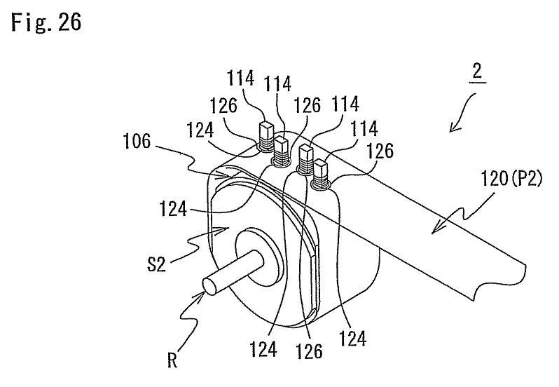

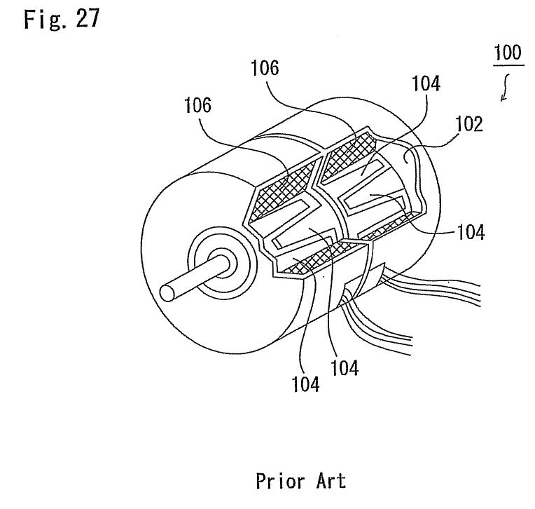

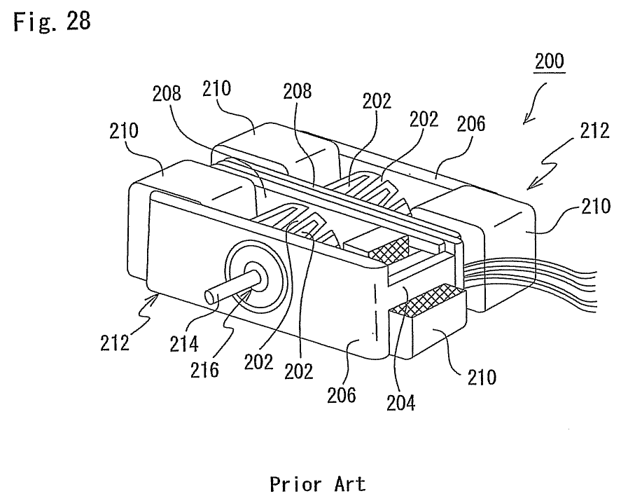

Next, a motor 2 in accordance with another embodiment in which a resin film member is wound around an outer peripheral face of a stator will be described in detail below with reference to the accompanying drawings. FIG. 21 is a partially cross-sectional view showing a motor in accordance with another embodiment in which a rotor is disposed on an inner side of a stator. FIG. 22 is an exploded perspective view of the stator in FIG. 21. FIG. 23 is a top plan view showing a state where the rotor is disposed on an inner side of the stator shown in FIG. 21. FIG. 24 is a plan view showing another example of a wiring circuit board which is a resin film member. FIG. 25 is a perspective view showing a state before terminals of a stator are inserted into through-holes of a wiring circuit board. FIG. 26 is a perspective view showing a state where a wiring circuit board has been wound around a stator and terminals have been inserted into connecting holes. In this motor 2, the same notational symbols are used in portions such as the rotor R having a similar structure as the motor 2 in accordance with the above-mentioned embodiment and their detailed descriptions are omitted.

The motor 2 in accordance with this embodiment is a stepping motor. As shown in FIG. 21, the motor 2 includes a rotor R having a rotor shaft RS and a cylindrical rotor magnet RM fixed to an outer peripheral face of the rotor shaft RS, and a stator S2 which is disposed to surround the rotor R.

The stator S2 is structured as a two-phase structure in which a pair of stator members S21 is fixed to each other in a back-to-back manner.

As shown in FIG. 22, the stator member S21 includes stator cores 100 which are formed with a plurality of pole teeth 103 disposed to surround around the rotor R, coils 102 disposed on an outer periphery of the pole teeth 10, and a motor case 106 provided with case parts 104a and 104b covering outer peripheral faces of the coils 102. The coil 102 may be structured of a coil with a coil bobbin or structured of a bobbin-less coil. A yoke of the stator member S21 is structured by assembling the stator cores 100 and the motor cases 106.

As shown in FIG. 22, the motor case 106 is provided with a ring-shaped cover part 106a having an inner diameter smaller than an inner diameter of the coil 102 and having an outer diameter larger than an outer diameter of the coil 102. A pair of the case parts 104a and 104b is formed to be bent from an outer peripheral edge of the cover part 106a in a circular arc shape so as to face each other, and a plurality of pole teeth 103 is formed to be bent from its inner peripheral edge. When the coil 102 is disposed so as to surround a plurality of the pole teeth 103, the outer peripheral face of the coil 102 is partially covered with the case parts 104a and 104b, and a part of the coil 102 is visually exposed through an opening part 108 between the case part 104a and the case part 104b. The motor case 106 is formed of a magnetic steel plate such as iron, which is press-worked.

As shown in FIG. 22, a tip end face of the case part 104a is formed with a cut-out part 110 for drawing a coil wire 102a, which is an end part of the coil 102 mounted on inside of the motor case 106, to the outside of the motor case 106. Further, an end face of the case part 104b is formed at a position opposed to the cut-out part 110 for coil wire with a cut-out part 112 for protruded part into which a protruded part 118 of the stator core 100 described below is inserted.

The stator core 100 is, similarly to the cover part 106a of the motor case 106, is formed in a roughly ring shape so as to have an inner diameter smaller than the inner diameter of the coil 102 and an outer diameter larger than an outer diameter of the coil 102. A plurality of the pole teeth 103 is formed to be bent from an inner circumferential edge of the stator core 100 so as to be adjacently disposed to the pole teeth 103 of the motor case 106. Further, a terminal block 116 which holds terminals 114 for connecting the coil wire 102a of the coil 102 is attached to an outer peripheral edge portion of the stator core 100. The protruded part 118 is formed at a position opposed to the terminal block 116 so as to be capable of positioning the stator cores 100 of the stator member S21 each other. In this embodiment, the stator core 100 is formed of a magnetic steel plate such as iron, which is press-worked. Further, the terminal block 116 is formed of synthetic resin material having insulation property or the like.

The coil 102 mounted on the outer side of the pole teeth 103 of the stator core 100 may be structured as a bobbin-less coil. In this case, the bobbin-less coil is structured such that a coil wire provided with a self fused layer on a surface of the coil wire such as a copper wire is wound around a plurality of times. For example, when the coil wire having the self fused layer is wound around a jig having a predetermined outer diameter while being heated, the surface of the coil wire is fused and bonded to be formed in a shape of the bobbin-less coil 102 or, after a coil wire is wound around to be formed in a shape of the bobbin-less coil 102, the bobbin-less coil 102 is fused and bonded by solvent or the like. In this manner, even when a coil bobbin is not used, the shape of the bobbin-less coil 102 can be maintained.

For example, the stator S2 is assembled as follows. First, the stator cores 100 of the stator member S21 are superposed on each other in a back-to-back manner and positioned by superposing the protruded parts 118 formed at the outer peripheral edge on each other. Then, outer peripheral end faces of the stator cores 100 are joined by welding. After that, the terminal block 116 is mounted at the outer peripheral edge of the joined stator cores 100 by insert or outsert molding of synthetic resin material. After that, the stator cores 100, the bobbin-less coils 102 and the motor cases 106 are made to move closer to each other under a state that they are coaxially disposed so that the surfaces of the bobbin-less coils 102 are not contacted with the pole teeth 103 of the stator core 100 and the motor case 106 and, as a result, the bobbin-less coils 102 are disposed on an outer side of the pole teeth 103. After that, the motor case 106 and the stator core 100 are joined with each other by welding to assemble the stator S2. Then, the coil wires 102a of the bobbin-less coil 102 are bound on the terminals formed in the terminal block.

The rotor which is disposed on the inner side of the stator S2 is rotatably supported by bearings.

As shown in FIG. 23, since the motor case 106 is provided with opening parts 108, the motor case 106 is formed in a roughly oval shape such that an outer peripheral face of a cylindrical shape is cut out in a roughly parallel manner. Further, an outer peripheral face of the stator core 100 is also formed in a roughly oval shape so as to correspond to the motor case 106. Therefore, an outer peripheral shape of the stator S2 is similarly formed in the roughly oval shape. As described above, the outer peripheral shape of the stator S2 is formed in the shape that the outer peripheral face of a cylindrical shape is cut out in a roughly parallel manner and thus an outside dimension of the stator S2 can be made smaller to reduce the size of the motor 2.

In this embodiment, the opening part 108 is formed in the motor case 106. Therefore, as shown in FIG. 21, the outer peripheral face of the coil 102 is exposed in the outer peripheral face of the stator S2 through the opening part 108. When the outer peripheral face of the coil 102 is exposed from the outer peripheral face of the stator S2 as described above, the outer peripheral face of the coil 102 may be carelessly pressed or scratched and thus the coil wire is disconnected.

In order to solve the problem described above, a resin film member P2 having flexibility is wound around the outer peripheral face of the stator S2 to cover the opening part 108 of the motor case 106 and the outer peripheral face of the coil 102 exposed from the opening part 108 is protected. In accordance with this embodiment, a wiring circuit board 120 in which electro-conductive wiring patterns are formed on an insulating base film are utilized as the resin film member P2.

FIG. 24 is a plan view showing the wiring circuit board 120 in which a part of resin film is cut out for showing wiring patterns. The wiring circuit board 120 is formed in a band shape having a width W2 which is roughly the same length h2 in the axial direction of the stator S2 so as to be capable of covering the outer peripheral face of the stator S2, which is structured of two stator members S21 superposed on each other, with a sheet of the wiring circuit board 120. A flexible wiring circuit board which is commonly referred to as a flexible printed circuit board (FPC) may be utilized as the wiring circuit board 120. The wiring circuit board 120 is formed so that a conductor foil such as copper is laminated on a base film 120a made of resin having insulation property such as polyimide and patterning is performed on the conductor foil by etching in specific shapes to form the wiring patterns 120b and then a resin film 120c having insulation property such as polyimide is laminated on the wiring pattern 120b so as to cover roughly the entire base film 120a.

As shown in FIGS. 24 and 25, fixing through-holes 122 are formed on one end side of the wiring circuit board 120 at positions corresponding to the terminals 114 provided on the outer periphery of the stator S2. The fixing through-hole 122 is used for the wiring circuit board 120 to tightly contact with and to fix to the outer periphery of the stator S2 but is not connected to the wiring pattern 120b. The wiring circuit board 120 is formed with connecting through-holes 124 at positions on a center side of the fixing through-holes 122. The fixing through-holes 122 and the connecting through-holes 124 are arranged in correspondence with positions of the respective terminals 114 supported by the terminal block 116, and the respective terminals 114 can be respectively inserted into the fixing through-holes 122 and the connecting through-holes 124.

Terminal connecting parts 126 to which the respective inserted terminals 114 are electrically connected are formed at a periphery of the connecting through-hole 124 so as to surround the connecting through-hole 124. The terminal connecting part 126 is integrally formed with the conductor foil in the same layer as the wiring pattern 120b, and the resin film 120c on the terminal connecting part 126 is removed to expose the conductor foil, which can be connected to the terminal 114 with solder or the like.

A connecting part 128 for connector is formed in the other end part of the wiring circuit board 120. The connecting part 128 for connector is integrally formed with the conductor foil in the same layer as the wiring pattern 120b, and the resin film 120c on the connecting part 128 for connector is removed to expose the conductor foil, which can be connected to connector terminals or the like.

An FPC connector which has been commonly used is utilized for a connector which is connected to the connecting part 128 for connector and thus detailed description of its structure is omitted. Electric currents I3 and I4 are supplied to the connecting part 128 for connector to supply to the coils 102 through the FPC connector.

The wiring pattern 120b of the wiring circuit board 120 is formed so as to be respectively connected to the coils 102 provided in the respective stator members S21 of the stator S2.

First, as shown in FIG. 25, the terminals 114 provided in the stator S2 are inserted into the fixing through-holes 122 which are formed in the wiring circuit board 120. The wiring circuit board 120 is inserted to a position where the wiring circuit board 120 is abutted with the terminal block 116 which holds the terminals 114.

After that, as shown in FIG. 26, the wiring circuit board 120 is wound around the stator S2 so as to surround the outer peripheral face of the stator S2 and, when the wiring circuit board 120 is turned one round, the connecting through-holes 124 are reached to the positions of the terminals 114 and thus the terminals 114 are inserted into the connecting through-holes 124.

After that, in the state that the terminals 114 have been inserted into the connecting through-holes 124, the respective terminals 114 are soldered and connected to the terminal connecting parts 126 formed around the connecting through-holes 124.

In the respective stator members S21 of the stator S2, an electric current 13 inputted from the connecting part 128-1 for connector is supplied to the terminal connecting part 124-1 through a wiring pattern 120b and then inputted to one end of one of the coils 102 through the terminal 114 connected to the terminal connecting part 124-1 and outputted from the other end of the coil through the terminal 114 connected to the terminal connecting post 124-2 and then supplied to the connecting part 128-2 for connector through the wiring pattern 120b.

In this manner, the wiring circuit board 120 is connected to the terminals provided in the stator S2 and the wiring circuit board 120 is wound to surround the outer peripheral face of the stator S2 to structure the motor 2.

According to the motor 2 as described above, the opening parts 108 provided in the motor case 106 of the stator member S21 are covered by the wiring circuit board 120 which is the resin film member P2 and thus the outer peripheral face of the coil 102 exposed from the opening parts 108 is covered by the wiring circuit board 120. Therefore, the outer peripheral face of the coil 102 is not touched directly from the outside and thus the coil winding is prevented from being disconnected. In addition, since the outer peripheral faces of the coils 102 are covered by the resin film member comprising of the wiring circuit board 120, the motor 2 is easily handled. Further, since the wiring circuit board 120 is utilized as the resin film member for covering and protecting the outer peripheral face of the coils 102, the resin film member is provided with a function for supplying an electric current to the coils 102 and thus the size of the motor 2 can be reduced.

Although the present invention has been shown and described with reference to specific embodiments, various changes and modifications will be apparent to those skilled in the art from the teachings herein. For example, it may be structured so that a plurality of resin film members is wound around the outer peripheral face of the coils 102.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor which includes a rotor shaft and a rotor magnet provided on an outer peripheral face of the rotor shaft;
a first yoke and a second yoke which are disposed to face each other; and
at least one coil which is disposed between the first yoke and the second yoke;
wherein the first yoke is provided with a fixing part on which the coil is mounted so as to extend in a direction parallel to the rotor shaft and the fixing part is formed with a projecting part which is protruded from a tip end of the fixing part;
wherein the second yoke is provided with a fixing hole which is penetrated through from one face of the second yoke opposed to the first yoke to an other face of the second yoke;
wherein the projecting part formed at the tip end of the fixing part of the first yoke is press-fitted to the fixing hole of the second yoke and, in a state where the projecting part is press-fitted to the fixing hole, a tip end face of the fixing part is abutted with the one face of the second yoke and a tip end part of the projecting part is protruded from the other face of the second yoke.

2. The motor according to claim 1, wherein the tip end part of the projecting part is formed with a tapered face.

3. The motor according to claim 1, wherein an outer peripheral face of the tip end part of the projecting part of the first yoke and an opening edge part of the fixing hole of the second yoke are welded so that the first yoke and the second yoke are fixed to each other.

4. The motor according to claim 3, further comprising
a joining plate which is contacted with the second yoke and formed with the fixing hole to which the projecting part is press-fitted;
a frame which is mounted on the second yoke; and
a mounting part which is provided in the frame so as to abut with and be fixed to the joining plate and which is provided with a recessed part formed at a position corresponding to the fixing hole of the second yoke.

5. The motor according to claim 4, wherein an inner peripheral face of the fixing hole is formed with an abutting part which abuts with a surface of the fixing part and a recessed part which faces the surface of the fixing part through a gap space.

6. The motor according to claim 5, wherein the fixing hole is formed in a polygonal shape and the recessed part is formed at a corner part of the polygonal shape.

7. The motor according to claim 5, wherein the fixing hole is formed in a rectangular shape and the recessed part is formed in a longitudinal direction of the rectangular shape.

8. The motor according to claim 1, further comprising:
a joining plate which is contacted with the second yoke and formed with the fixing hole to which the projecting part is press-fitted;
a frame which is mounted on the second yoke; and
a mounting part which is provided in the frame so as to abut with and be fixed to the joining plate and which is provided with a recessed part formed at a position corresponding to the fixing hole of the second yoke.

9. The motor according to claim 8, wherein an inner peripheral face of the fixing hole is formed with an abutting part which abuts with a surface of the fixing part and a recessed part which faces the surface of the fixing part through a gap space.

10. The motor according to claim 9, wherein the fixing hole is formed in a polygonal shape and the recessed part is formed at a corner part of the polygonal shape.

11. The motor according to claim 9, wherein the fixing hole is formed in a rectangular shape and the recessed part is formed in a longitudinal direction of the rectangular shape.
